(19) United States
(12) Patent Application Publication
(10) Pub. No.: US 2025/0333939 A1
(43) Pub. Date: Oct. 30, 2025

(54) SHOWERING CONTROL USING LOAD-BASED OCCUPANCY DETECTION

(71) Applicant: Kohler Co., Kohler, WI (US)

(72) Inventors: Jason M. Kwacz, Kohler, WI (US); M P. Sakthiyanandan, Pune (IN); Prasanth Jayakumar, Pune (IN)

(73) Assignee: Kohler Co., Kohler, WI (US)

(21) Appl. No.: 19/187,106

(22) Filed: Apr. 23, 2025

Related U.S. Application Data
(60) Provisional application No. 63/638,582, filed on Apr. 25, 2024.
(60) Provisional application No. 63/638,583, filed on Apr. 25, 2024.

(51) Int. Cl. E03C 1/04; B05B 12/04; E03C 1/05

(52) U.S. Cl. CPC E03C 1/0408; B05B 12/04; E03C 1/057

(57) ABSTRACT

A control system for operating a showering system using load-based occupancy detection includes a spray head actuator, a position sensor, and a controller. The spray head actuator is configured to control a spray generated by a spray head. The position sensor is configured to generate a position signal indicative of a user location within a shower enclosure based on a load applied to the position sensor. The controller is communicably coupled to the position sensor and the spray head actuator, and is configured to determine a spray characteristic of a spray produced by the spray head based on the position signal, and control the spray head actuator based on the spray characteristic.

### CROSS-REFERENCE TO RELATED APPLICATIONS

The present application claims the benefit of and priority to U.S. Patent Application No. 63/638,583, filed Apr. 25, 2024, and U.S. Patent Application No. 63/638,582, filed Apr. 25, 2024, the entire disclosures of each of which are hereby incorporated by reference herein.

### BACKGROUND

The present disclosure relates generally to spray head control systems for showerheads and hand showers.

### SUMMARY

One aspect relates to a spray head control system for controlling a spray head using load-based occupancy and/or occupant positioning detection. The control system includes a spray head actuator, a position sensor, and a controller. The spray head actuator is configured to control a spray generated by a spray head. The position sensor is configured to generate a position signal indicative of a user location within a shower enclosure based on a load applied to the position sensor. The controller is communicably coupled to the position sensor and the spray head actuator and is configured to: receive the position signal from the position sensor; determine a spray characteristic of a spray produced by the spray head based on the position signal; and control the spray head actuator based on the spray characteristic.

Another aspect relates to a spray head control system including a plurality of conductive foam mats and a controller. The conductive foam mats are configured to be disposed across at least a portion of a surface of a shower tray. Each of the plurality of conductive foam mats includes an excitation terminal and an output terminal. The controller is configured to be electrically coupled the output terminal of each of the conductive foam mats. The controller is configured to control an actuator of a spray head based on electrical signals received from the output terminals.

Another aspect relates to a method for controlling an actuator of a spray head. The method includes receiving a position signal from a position sensor that is indicative of a user location within a shower enclosure; determining a spray characteristic of a spray based on the position signal; and controlling an actuator of a spray head based on the spray characteristic.

Another aspect relates to a control system for a showering system. The control system includes a spray head actuator, a position sensor, and a controller. The spray head actuator is configured to control a spray generated by the showering system. The position sensor is configured to generate a position signal based on a load applied to the position sensor. The controller is communicably coupled to the position sensor and the spray head actuator, and is configured to determine a user location of a user within a shower enclosure based on the position signal, and control the spray head actuator to adjust a spray characteristic of the spray based on the user location.

Another aspect relates to a control system for a showering system using microphone-based occupancy and/or occupant positioning detection. The control system includes a spray head actuator, a microphone, and a controller. The spray head actuator is configured to control a spray generated by the showering system. The microphone is configured to generate an audio signal from audio data regarding the spray. The controller is communicably coupled to the microphone and the spray head actuator. The controller is configured to (i) receive the audio signal; (ii) determine a spray characteristic indicative of the spray based on the audio signal; and (iii) control the spray head actuator to adjust the spray based on the spray characteristic.

In some embodiments, the spray head actuator includes a solenoid valve, and the controller is configured to control the solenoid valve to adjust a flow rate of water through a spray head based on the spray characteristic.

In some embodiments, the spray characteristic is a sound produced by the spray.

In some embodiments, the controller is configured to determine the spray characteristic by determining a Fourier transform of the audio signal; and comparing the Fourier transform with existing audio signal datasets using a classifier.

In some embodiments, the controller is further configured to: store a plurality of datasets of audio signals corresponding to a plurality of spray characteristics; and train a classifier to associate each of the plurality of datasets with a respective one of the plurality of spray characteristics.

In some embodiments, the control system further includes a cloud infrastructure component communicably coupled to the controller, the controller configured to determine the spray characteristic indicative of the spray by transmitting the audio signal to the cloud infrastructure component.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a control system for controlling a shower system using load-based occupancy detection, according to an embodiment.

FIG. 2 is a side view of a shower tray assembly that may be used with the control system of FIG. 1, according to an embodiment.

FIG. 3 is a top view of a rosette strain gauge for a shower tray assembly, according to an embodiment.

FIG. 4 is a top view of a Wheatstone bridge strain gauge for a shower tray assembly, according to an embodiment.

FIG. 5 is a block diagram of a shower controller that may be used with the control system of FIG. 1, according to an embodiment.

FIG. 6 is a flow diagram of a method of load-based occupancy detection and spray head control for a showering system, according to an embodiment.

FIG. 7A is a side view of a shower system including the control system of FIG. 1, showing different flow rate zones for the shower system.

FIG. 7B is a top view of the shower system of FIG. 7A.

FIG. 8 is a top view of a shower tray assembly that includes a single position sensor to determine a user's location between a plurality of zones along the shower tray assembly, according to an embodiment.

FIGS. 9-11 are side views of a shower system being controlled by a load-based occupancy detection system between three states of operation, according to an embodiment.

FIG. 12A is a side view of a shower system of FIG. 7A, during a fall event of a user within the shower.

FIG. 12B is a top view of the shower system of FIG. 12A.

FIG. 13 is a perspective view of a conductive foam position sensor in a first state of operation, according to an embodiment.

FIG. 14 is a perspective view of the conductive foam position sensor of FIG. 13, shown in a second state of operation.

FIG. 15 is a top view of a shower tray assembly that includes a plurality of conductive foam positions sensors, according to an embodiment.

FIGS. 16-18 are side views of a shower system being controlled by a load-based occupancy detection system between three states of operation, according to another embodiment.

FIG. 19 is a block diagram of a control system for a shower system that includes a plurality of position sensors made from conductive foam, according to an embodiment.

FIG. 20 is a block diagram of a control system for controlling a shower system using load-based occupancy detection, according to another embodiment.

FIG. 21 is a block diagram of a control system for controlling a shower system using load-based occupancy detection, according to still another embodiment.

FIG. 22 is a block diagram of a control system for controlling a shower system using microphone-based occupancy detection, according to an embodiment.

FIG. 23 is a block diagram of a showering system inclusive of a microphone-based occupancy detection system, according to an embodiment.

FIG. 24 is a block diagram of the control system of FIG. 23.

FIG. 25 is a side view of a shower enclosure inclusive of the showering system of FIG. 23 shown with a user in a first position, according to an embodiment.

FIG. 26 is a side view of a shower enclosure inclusive of the showering system of FIG. 23 shown with a user in a second position farther away from a spray head assembly of the showering system than the first position of FIG. 25, according to an embodiment.

FIG. 27 is a method of controlling a showering system using microphone-based occupancy detection, according to an embodiment.

FIG. 28 is a method of determining a spray parameter of a spray generated by a showering system using a machine learning algorithm, according to an embodiment.

FIG. 29 is a side view of a showerhead assembly that includes a microphone-based occupancy detection system, according to an embodiment.

FIG. 30 is a side view of a control module for the microphone-based occupancy detection system of FIG. 8, shown with a housing cover removed.

FIG. 31 is another side view of the control module of FIG. 30, showing a flow path through the control module.

FIG. 32 is a perspective view of the control module of FIG. 30, showing a microphone port for the control module.

FIG. 33 is a top view of the control module of FIG. 30, showing a diagnostic and programming connector port for the control module.

FIG. 34 is a block diagram of an electronic start-up system for a microphone-based occupancy detection system, according to an embodiment.

FIG. 35 is a block diagram of a mechanically actuated start-up system for a microphone-based occupancy detection system, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Aspects of the present disclosure relate to occupancy detection systems that are configured to determine a location of a user (or users) within a shower enclosure and to vary one or more flow parameters of the showering system based on the location.

In some embodiments, the occupancy detection system is or includes a load-based occupancy and/or occupant position detection system that can be used to vary one or more flow parameters of the showering system, such as a flow rate through a showerhead and/or hand shower depending on the location of the user within a shower enclosure as determined based on position sensor measurements (e.g., load sensor measurements, etc.). In at least one embodiment, the detection system is configured to determine a location of a user within the shower enclosure based on sensor data from position sensors that are coupled to a shower tray assembly of the shower system. For example, the occupancy detection system may be configured to determine the location of the user based on position signals from one or more load cells coupled to the shower tray. The occupancy detection system may be configured to control various characteristics of sprays generated by the showerhead and/or hand shower based on the location of the user, such as by reducing a flow rate of water through the showerhead or hand shower, which can reduce overall water consumption during periods when the spray generated by the spray head is not being fully utilized, such as when the user has stepped away from the showerhead and is applying shampoo or soap to their body, during shaving, when waiting for the water to heat up, or during other user activities conducted away from a main spray area of the showerhead. Such arrangements can also improve the user experience by tailoring the spray intensity and/or shape to user movements within the shower enclosure.

In some embodiments, the occupancy detection system is or includes a microphone-based occupancy and/or occupant position detection system that can be used to vary one or more flow parameters of the showering system, such as a flow rate through a shower head and/or hand shower depending on the location of the user within a shower enclosure. In at least one embodiment, the detection system is configured to determine a location of a user within the shower enclosure based on audio data regarding a spray produced by the showering system. For example, the occupancy detection system may be configured to determine the location of the user based on the sound of water reflecting off a floor and/or shower tray of the shower enclosure, and/or based on the sound of water reflecting off different portions of a user's body. In some embodiments, the occupancy detection system may use machine learning algorithm to identify one or more spray characteristics associated with a three-dimensional shape of the spray within the shower enclosure. The occupancy detection system may be configured to control the shower head and or hand shower based on the location of the user or the shape of the spray, such as by reducing a flow rate of water through the showerhead or hand shower, which can reduce overall water consumption during periods when the spray is not being fully utilized (e.g., such as when the user is applying shampoo or soap to their body, during shaving, etc.).

### Load-Based Occupancy Detection System

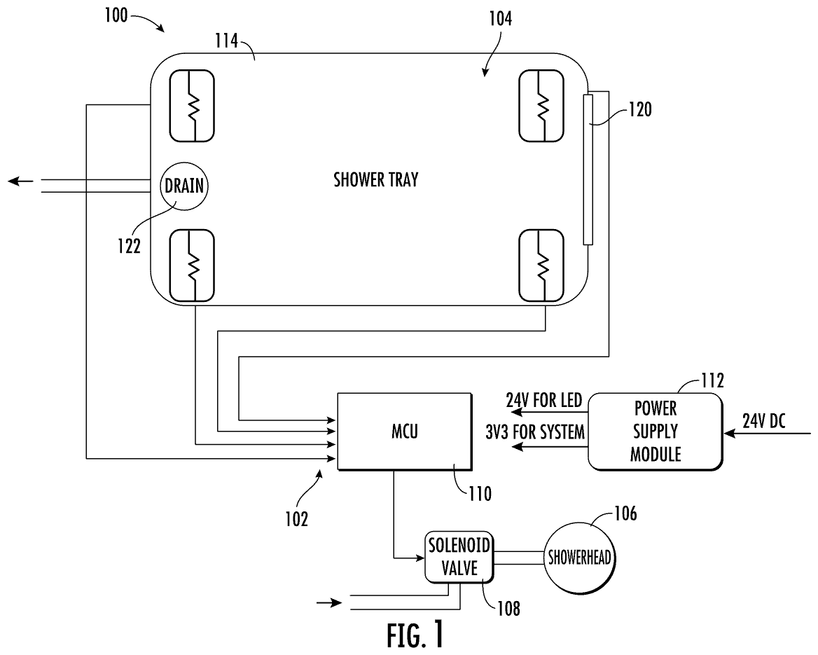

Referring to FIG. 1, a load-based occupancy detection system, shown as occupancy detection system 102 (which also may be referred to as a spray head control system), for a showering system 100 is shown, according to an embodiment. The showering system 100 includes a shower tray assembly 104, a spray head 106 (e.g., a showerhead, a hand shower, etc.), at least one actuator 108, a controller 110, and a power source 112. In other embodiments, the showering system 100 may include additional, fewer, and/or different components.

The shower tray assembly 104 is configured to generate sensor data and/or position signals indicative of a user's position along the shower tray assembly 104. The shower tray assembly 104 includes a shower tray 114 and a position sensor 118. In other embodiments, the shower tray assembly 104 may include additional, fewer, and/or different components. For example, in some embodiments, the shower tray assembly 104 also includes a tray support 116 and/or a user interface 120.

In some embodiments, and as shown, the shower tray 114 defines at least a portion of a floor of a shower enclosure for the showering system 100. In the embodiment of FIG. 1, the shower tray 114 includes a wall defining a drain opening 122. The drain opening 122 is coupled to a drain conduit and is configured to (i) capture water from the spray head 106, and (ii) direct captured water to the drain conduit.

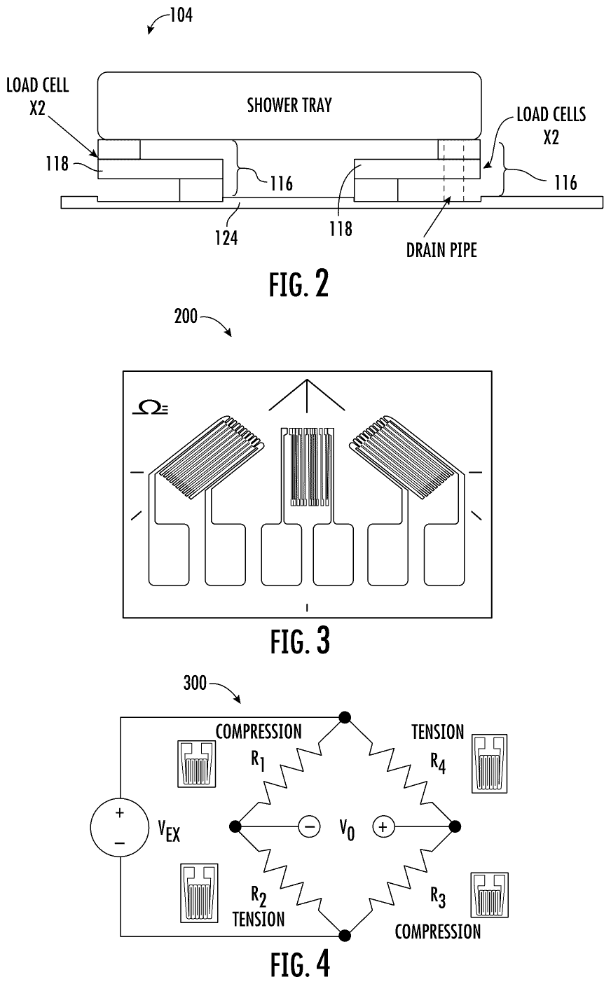

Referring to FIG. 2, the tray support 116 is configured to secure the shower tray 114 to a base wall 124 and/or frame of a shower enclosure. The tray support 116 may be fastened to the shower tray 114 using mechanical fasteners (e.g., bolts, screws, rivets, etc.). In other embodiments, the tray support 116 is welded to the shower tray 114 or integrally formed with the shower tray 114 as a monolithic body from a single piece of material. In some embodiments, the shower tray assembly 104 includes a plurality of tray supports 116 that secure different portions of the shower tray 114 to the base wall 124 and/or frame of the shower enclosure. In some embodiments, the shower tray 114 is at least partially suspended above the base wall 124 and/or frame of the shower enclosure by the tray support(s) 116.

In the embodiment of FIG. 2, the tray support 116 is coupled to the shower tray 114 proximate to an outer perimeter edge of the shower tray 114 so that the shower tray 114 is cantilevered outwardly from the tray support 116 (e.g., so that the position sensor 118 is cantilevered between the shower tray 114 and the base wall 124). In some embodiments, the shower tray assembly 104 includes tray supports proximate to each corner of the shower tray 114. In some embodiments, the shower tray assembly 104 further includes a drainpipe that extends between the drain opening 122 and the base wall 124 in an area between the tray supports.

The position sensor 118 is configured to generate a position signal (e.g., position data, a voltage, etc.) based on a load applied to the position sensor 118. In some embodiments, the position sensor 118 includes a strain gauge that is configured to measure loads applied to the shower tray 114 and/or the tray support 116. The position sensor 118 may include a single strain gauge, or a combination of strain gauges oriented at different angles with respect to one another. For example, referring to FIGS. 3-4, the position sensor 118 may include a rectangular rosette strain gauge 200 including three strain gauges oriented at 45° angles with respect to one another (e.g., 0-45-90 as shown in FIG. 3), and/or a Wheatstone bridge 300 that includes four strain gauges oriented at 90° angles with respect to one another (e.g., at 0°, 90°, 180°, and 360° as shown in FIG. 4). Different arrangements of strain gauges may be used in other embodiments. In still further embodiments, the position sensor 118 includes another type of load cell, such as a conductive mat, as described in further detail below.

The position sensor 118 may be coupled to the shower tray 114 and/or the tray support 116. In the embodiment of FIG. 2, the position sensor 118 is directly coupled to the tray support 116, such as along a sidewall of the tray support 116. In other embodiments, the position sensor 118 may be disposed between the shower tray 114 and the tray support 116, and/or along a lower surface of the shower tray 114. In yet other embodiments, the position sensor 118 is positioned on an upper surface of the shower tray 114, such as when a conductive mat is used as the position sensor 118, as will be further described.

The user interface 120 is configured to provide an indication of an operating status of the load-based occupancy detection system and/or other parts of the showering system 100 to a user. For example, the user interface 120 may include light elements to visually notify a user of the user's position (e.g., the user location, etc.) along the shower tray 114. For example, the user interface may include light elements to indicate the zone in which the user is standing or positioned, for example, by using red-green-blue light indication corresponding with different zones. In other embodiments, the user interface 120 may also be configured to display or otherwise indicate an operating condition of the spray head 106 (see FIG. 1). In some embodiments, the user interface 120 includes a light panel or strip extending across a portion of the shower tray 114 (see FIG. 1). In other embodiments, the user interface 120 includes a touchscreen interface or another human-machine interface that can also receive commands from a user, as described in more detail below. In other embodiments, the user interface 120 may be located remote from the shower tray 114. For example, the user interface 120 may form part of a controller for the load-based occupancy detection system.

Referring again to FIG. 1, the spray head 106 is configured to fluidly couple to a fluid source (e.g., a well, a plumbing system, etc.) and to discharge the fluid from the fluid source onto the shower tray assembly 104.

In some embodiments, the spray head 106 is part of a spray head assembly that includes a fluid communication adapter and/or member (e.g., a ball joint, a threaded coupler, etc.) that is configured to fluidly couple the spray head 106 to a fluid delivery component (e.g., a pipe, a spout, a fixture, a shower arm, etc.) such that the spray head 106 can receive the fluid from a fluid source. In some embodiments, the fluid delivery component is a water supply conduit that is configured to supply water at residential and/or commercial water supply pressures to the spray head 106.

In some embodiments, the spray head 106 forms part of a hand shower and/or a pull-out spray head, where the spray head 106 can be selectively repositioned respect to the fluid delivery component. Alternatively, the spray head 106 may be a showerhead that is positioned at a fixed height relative to the shower tray assembly 104. In yet other embodiments, the spray head 106 may be part of a spray head assembly that includes a combination of a showerhead and a hand shower.

The actuator 108 is configured to adjust a characteristic of the spray produced by the spray head 106 (e.g., a state of activation, a spray pattern produced, etc.). In some embodiments, the actuator 108 is a separate component from the spray head 106. For example, the actuator 108 may be flow actuator and/or shower valve disposed in a fluid delivery component upstream from the spray head 106. In other embodiments, the actuator 108 may form part of a spray head assembly that includes the spray head 106. For example, the actuator 108 may be disposed within a housing of a showerhead or a hand shower.

In the embodiment of FIG. 1, the actuator 108 includes a solenoid valve that is configured to adjust one or more of a flow rate through a spray head 106, activation of a subset of nozzles of the spray head 106, a spray pattern produced by the spray head 106, and/or another characteristic of the spray produced by the spray head 106.

In some embodiments, the solenoid valve is a pulse width modulated solenoid valve that is configured to control one of a duty cycle or frequency of actuation. In some embodiments, the solenoid valve may be one of a plurality of solenoid valves that are configured to collectively control spray characteristics of the spray. As used herein, “spray characteristic” refers to features of the spray produced by the spray head 106. For example, the spray characteristic may include an overall flow rate of water produced by the spray, an intensity of the spray (e.g., a flow rate of the spray per nozzle along the spray head 106, etc.), a spray pattern, a number of droplets produced by a nozzle (e.g., each nozzle) per second, a number of sprays, or another characteristic of the spray produced by the spray head 106 or a combination of spray heads.

In other embodiments, the actuator 108 is one of a plurality of actuators that are configured to control the flow rate to different spray heads of the showering system 100. In yet other embodiments, the actuator 108 is a thermostatic valve that is configured to control a fraction of hot water being delivered to the spray head 106.

The occupancy detection system 102 is configured to determine a user's position (e.g., the user location, etc.) along/over the shower tray assembly 104 and to control the actuator(s) 108 to adjust the spray characteristic based on the user location. In the embodiment of FIG. 1, the occupancy detection system 102 is configured to adjust the spray characteristic depending on where the user is located relative to the spray head 106, such as a distance between the user and the spray head 106, and/or based on a user location of the user relative to a center of the spray pattern produced by the spray head 106 with the actuator 108 is in fully opened (e.g., when water is provided to the spray head 106 at residential line pressure, when the solenoid valve upstream of the spray head 106 is fully open, etc.). In some embodiments, the occupancy detection system 102 is also configured to identify fall events corresponding with a user slipping or falling onto the shower tray assembly 104.

The controller 110 is configured to receive position signals from the position sensor(s) 118 and to control operation of the actuator 108 based on the position signals. The power source 112 is electrically coupled to the shower tray assembly 104 (e.g., the position sensor(s) 118), the actuator 108, and the controller 110, and is configured to power the shower tray assembly 104, the actuator 108, and the controller 110. In the embodiment of FIG. 1, the power source 112 includes a commercial or residential power source, such as line power from a utility. In other embodiments, the power source 112 may include a battery pack, such as a lithium-ion battery, which can eliminate the need for wall power and facilitate retrofit of the occupancy detection system 102 into exiting showering systems. In some embodiments, the power source 112 also includes a battery charger to power and/or recharge the battery pack.

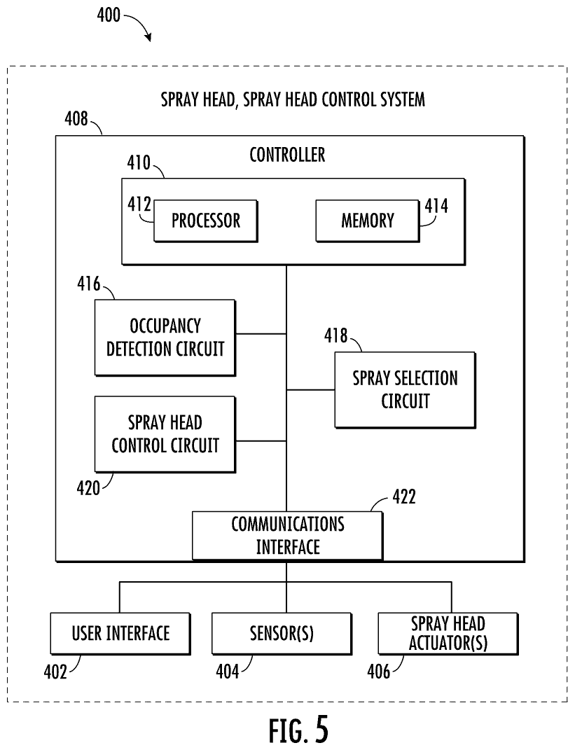

Referring to FIG. 5, an occupancy detection system 400 is shown that may be used with the showering system 100 of FIG. 1. The occupancy detection system 400 is structured as a standalone controller for the showering system that may be located remotely from a shower tray assembly and/or spray head assembly (see FIG. 1). In other embodiments, the occupancy detection system 400 and/or portions thereof may be fixedly coupled to the shower tray assembly and/or the spray head assembly.

The occupancy detection system 400 includes a user interface 402, a position sensor 404, an actuator 406, and a controller 408. In other embodiments, the occupancy detection system 400 may include additional, fewer, and/or different components.

The user interface 402 is configured as a human-machine interface for the occupancy detection system 400 and enables user interaction with the occupancy detection system 400. The user interface 402 may be the same as, or include at least portions of, the user interface 120 described with reference to FIG. 1. In some embodiments, the user interface 402 includes an input/output interface (e.g., an I/O interface) that is configured to receive user inputs. For example, the user interface 402 may include one or more actuators and or a touch screen display. In some embodiments, the user interface 402 is configured to allow a user to specify spray characteristics (e.g., flow parameters, number of active nozzles and/or spray heads, etc.) that the controller 408 may select based on the user location along a shower tray assembly, as will be further described. In some embodiments, the user interface 402 is configured to provide an indication of the user location determined by the controller 408. For example, the user interface 402 may include a display and/or at least one light element (e.g., a light emitting diode, etc.) configured to provide a visual and/or audible indication of where the user is located along the shower tray assembly.

The position sensor 404 is configured to generate a position signal indicative of a position of a user along/over the shower tray assembly. The position sensor may be the same as the position sensor(s) 118 described with reference to FIGS. 1-2.

The actuator 406 may be, or include, a shower valve that is configured to adjust the spray produced by the spray head assembly. The actuator(s) 306 may be the same as the actuator(s) 108 described with reference to FIG. 1.

The controller 408 is communicably coupled to the user interface 402, the position sensor(s) 404, and the actuator(s) 306, and is configured to receive and interpret data from and/or control operation of the user interface 402, the position sensor(s) 404, and the actuator(s) 406. In the embodiment of FIG. 5, the controller 408 includes a processing circuit 410 including a processor 412 and memory 414; an occupancy detection circuit 416 (e.g., an occupancy detection module, etc.); a spray selection circuit 418 (e.g., a spray selection module, etc.); a spray head control circuit 420 (e.g., a spray head control module, etc.); and a communications interface 422. In other embodiments, the controller 408 may include different arrangements of circuits. For example, in some embodiments, the user interface 402 may form part of the controller 408 and/or may be housed within the same enclosure as the controller 408.

The processor 412 is communicably coupled to the memory 414, the occupancy detection circuit 416, the spray selection circuit 418, the spray head control circuit 420, and the communications interface 422, and is configured to coordinate and control operations of each of the circuits and the communications interface 422. The memory 414 is configured to store data and/or computer code for facilitating the various processes described herein. The memory 414 may include a tangible non-transient volatile memory that is configured to store instructions thereon which when executed causes the processor 412 to perform any of the operations described herein.

In some embodiments, the occupancy detection circuit 416, the spray selection circuit 418, and the spray head control circuit 420 are embodied as software modules stored in memory 414. In such arrangements, the occupancy detection circuit 416, the spray selection circuit 418, and/or the spray head control circuit 420 may form part of an edge computing device that is configured to perform operations without requiring access to the Internet. In other embodiments, at least one of the occupancy detection circuit 416, the spray selection circuit 418, and the spray head control circuit 420 are embodied as a separate circuit or may form part of a cloud infrastructure component that is communicably coupled to the controller 408 via the Internet.

The occupancy detection circuit 416 is configured to determine a user location of a user along the shower tray assembly (e.g., along the shower tray, etc.) based on a position signal from the position sensor(s) 404. For example, the occupancy detection circuit 416 may be configured to receive the position signal and to determine a location of a user within a shower enclosure, relative to the spray produced by the spray head, and/or within different zones/areas of the shower tray. In some embodiments, the occupancy detection circuit 416 is also configured to identify certain events based on the position signal. For example, the occupancy detection circuit 416 may be configured to identify/determine a fall event that indicates a user has slipped or fallen while using the showering system, and/or that a user has dropped an object within the shower enclosure, as described in more detail below.

In at least one embodiment, the occupancy detection circuit 416 is configured to implement at least one machine learning and/or deep learning algorithm to identify the user location by comparing the position signal to reference data stored in memory 414. Such an approach can improve accuracy of the user location determination by tailoring the algorithm to a particular user and/or set of users that frequent the showering system (e.g., by tailing the algorithm based on individual user's weights, movement habits, showering preferences, etc.). In such embodiments, the occupancy detection circuit 416 may form part of an edge computing device (e.g., a chipset, an application specific integrated circuit, etc.) that is configured to generate and/or perform a position signal comparison algorithm using machine learning and/or deep learning without requiring access to the Internet or devices located remote from the shower enclosure. Such arrangements can reduce latency and improve response times between user actions and adjustments to the spray, and can also reduce overall system complexity.

In other embodiments, the occupancy detection circuit 416 may form or be hosted by a cloud infrastructure component that is communicably coupled to the controller 408 over the Internet via a wired network, a wireless network, or a combination thereof. For example, the at least portions of the occupancy detection circuit 416 may be formed as a software module that is accessible via an application programming interface (API), or other drivers stored in memory 414 onboard the controller 408. Such an arrangement can allow for over-the-air updates to software algorithms (e.g., machine learning algorithms, etc.) to improve determination of different user locations and the use of different control algorithms to adjust the spray based on user movements or actions.

The spray selection circuit 418 is configured to receive the user location and/or event (e.g., a fall event, etc.) from the occupancy detection circuit 416 and to determine a spray characteristic that corresponds with the user location and/or event. In some embodiments, the spray selection circuit 418 is configured to determine a control parameter for the actuator(s) 306 to cause the actuator(s) 306 to adjust the spray characteristic based on the user location and/or event(s) detected by the occupancy detection circuit, as will be further described.

In some embodiments, the spray selection circuit 418 is configured to control the actuator(s) 306 to adjust a flow rate of water produced by the spray head. For example, the spray selection circuit 418 may be configured to transmit a control signal to a solenoid to reduce a flow rate of water in response to a determination that the user is located outside of a primary spray zone for the spray head and/or shower tray assembly (e.g., to 50% of a maximum flow rate relative to a supply pressure of the fluid source, 40% of the supply pressure, 30% of the supply pressure, 20% of the supply pressure, 10% of the supply pressure, or any value between and including the foregoing values, etc.). Conversely, the spray selection circuit 418 may be configured to increase the flow rate in response to a determination that a user has stepped into the primary spray zone for the spray head and/or shower tray assembly (e.g., to 100% of the maximum flow rate, or a different value based on user preferences, etc.). Such an arrangement can significantly reduce the amount of water used during periods in which the user has moved away from the spray head, for example, to shampoo their hair, shave, and/or to perform other functions that do not require a full intensity spray.

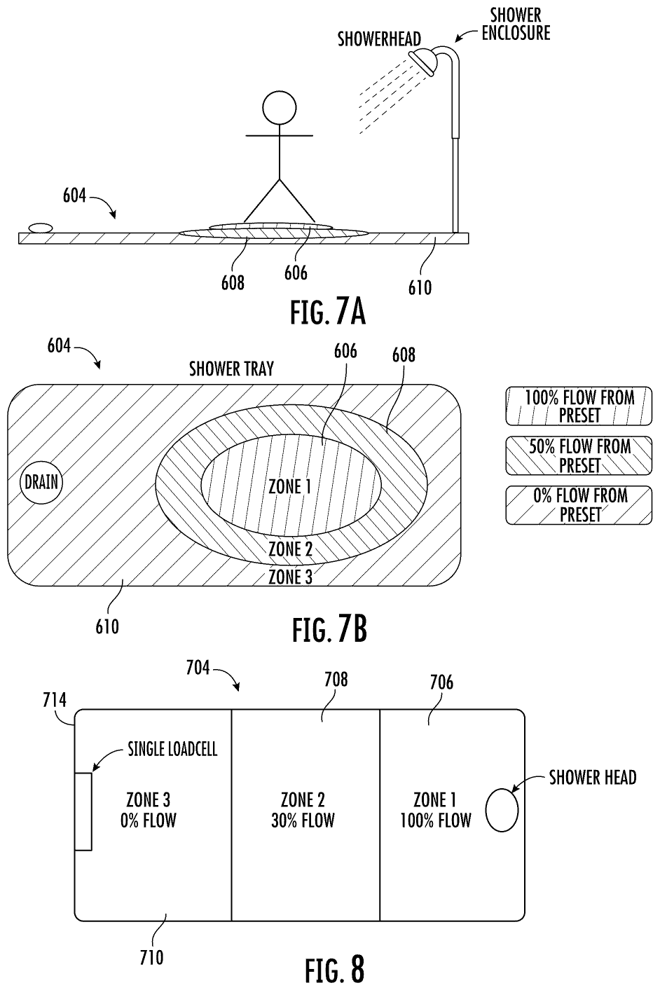

In some embodiments, the spray selection circuit 418 is configured to generate different control signals to provide intermediate spray intensities depending on a distance between the user and the spray head and/or a primary spray zone along the spray tray assembly. For example, referring to FIGS. 7A-7B, the spray selection circuit 418 (see also FIG. 5) may be configured to adjust the flow rate, intensity, or other spray characteristic of the spray depending on the user's position relative to a plurality of spray zones along the spray tray assembly.

In some embodiments, the spray selection circuit 418 is configured to control the actuators 406 to adjust a flow rate of water and/or another aspect of the spray based on user inputs and/or template spray patterns that are defined by a user and stored in memory 414.

Referring again to FIG. 5, the spray head control circuit 420 is configured to receive the spray characteristic from the spray selection circuit 418 and to generate and transmit a control signal to the actuator(s) 406 based on the spray characteristic. The control signal may cause the actuator(s) 406 to close, to change a duty cycle and/or frequency of a solenoid valve, or to activate/deactivate subsets of nozzles of one or more spray heads within the shower enclosure.

In some embodiments, the spray head control circuit 420 is also configured to receive events detected/identified by the occupancy detection circuit 416, and to generate notifications and/or alerts based on the events. For example, the spray head control circuit 420 may be configured to transmit an alert via a wired or wireless connection (e.g., via Bluetooth, the Internet, etc.) to a caretaker and/or emergency personnel (e.g., via a 911 call, etc.) responsive to a determination of a fall event or another event based on sensor signals received from the position sensors (e.g., by comparing the signals to threshold signals in memory, etc.).

Referring again to FIG. 5, the communications interface 422 is configured to control data exchange between various components of the showering system and the controller 408, and between the controller 408 and other devices. The communications interface 422 may include a wired and or wireless interface for conducting communications (e.g., Bluetooth, a local area network (LAN), cellular communications, near field communications, etc.).

### Method of Load-Based Occupancy Detection and Spray Head Control

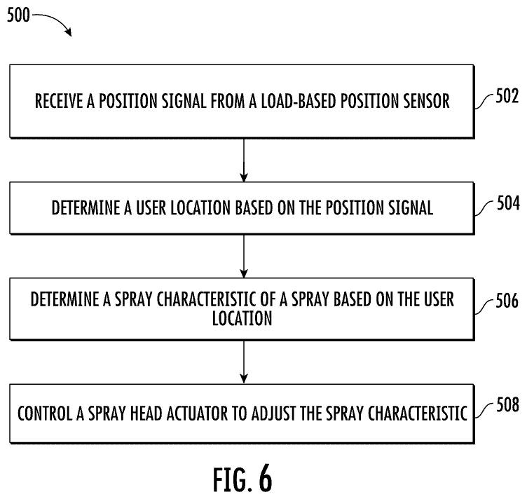

Referring to FIG. 6, a method 500 of load-based occupancy detection and spray head control for a showering system is shown, according to an embodiment. The method 500 may be implemented by the occupancy detection system 400 of FIG. 5 and, as such, will be described with reference to the occupancy detection system 400. In other embodiments, the method 500 may include additional, fewer, and/or different operations.

At operation 502, the controller (e.g., the controller 408, the occupancy detection circuit 416, etc.) receives a position signal (e.g., position data, etc.) from a load-based position sensor. In some embodiments, operation 502 includes generating, by a position sensor (e.g., position sensor 404), the position signal in response to a force exerted on a shower tray assembly by a user (e.g., a load exerted on a shower tray). The position signal may be indicative of a user location within the shower enclosure (along the shower tray) and/or relative to the spray head. In some embodiments, operation 502 includes determining components of strain in different directions and/or the shear strain, such as by using the strain gauge rosette equations. Operation 502 may include processing the position signal, such as via an analog to digital processor to facilitate further processing operations. In some embodiments, operation 502 includes determining a normalized strain value based on a user's weight and/or another parameter (e.g., based on weighting factors stored in memory, and/or other user inputs).

At operation 504, the controller (e.g., the occupancy detection circuit 416, etc.) determines a user location of the user along the shower tray assembly (e.g., the shower tray), relative to a spray head, and/or relative to a location at which a full flow rate spray may be directed, based on the position signal. In some embodiments, operation 504 includes determining the user location relative to a plurality of zones along the shower tray assembly. For example, operation 504 may include comparing the position signal and/or the determined components of strain (e.g., from operation 502) to a plurality of zone strain values and/or position values stored in memory. Each zone strain value and/or position value may correspond with the user being positioned in at least one of a plurality of zones.

For example, referring to FIGS. 7A-7B, a shower tray assembly 604 is shown that includes three zones centered about a center of the spray from the spray head (e.g., a center of the spray when the actuator is fully open, at full flow conditions through the spray head, etc.). In the embodiment of FIGS. 7A-7B, a first spray zone 606 (e.g., a primary spray zone, etc.) is a circular-shaped spray zone that located at the center of the spray. A second spray zone 608 is disposed radially outward from the first spray zone 606 in an annular region between the first spray zone 606 and a third spray zone 610. The third spray zone 610 extends radially away from an outer end of the second spray zone 608. In the embodiment of FIGS. 7A-7B, the second spray zone 608 is concentric with the first spray zone 606. In other embodiments, the relative position and/or shape of the zones may be different.

Referring again to FIG. 6, in some embodiments, operation 504 includes using a lookup table that includes a list of zone strain values and/or position data values that correspond with different user locations along the shower tray. The zone strain values may be determined based on experimental data, and/or based on a calibration performed by the user during initial operation of the showering system.

For example, a method of determining the zone strain values and/or calibrating the load-based occupancy detection system may include prompting a user to stand in a particular user location along the shower tray. In such embodiments, the method may include displaying a zone number and/or position graphically on a user interface so that the user knows where to stand along the shower tray. The method may include prompting the user (e.g., via the user interface, etc.) to notify the system that the user is standing in an area of the shower tray that was requested by the control system. The method may include determining a zone strain value that corresponds with the user location based on a position signal that is received from the position sensor while the user is standing within the zone. The method may include repeating this operation for each zone along the shower tray and/or for various actions/movements performed by the user.

In other embodiments, operation 504 includes using an algorithm to determine the user location based on the position signal. In some embodiments, operation 504 includes using a machine learning and/or deep learning algorithm to determine the user location from the position signal, such as by determining a predicted user location based on training data provided to the system/controller (e.g., training data including position data and/or strain gauge values corresponding with different user positions and labeled to indicate the user position(s)).

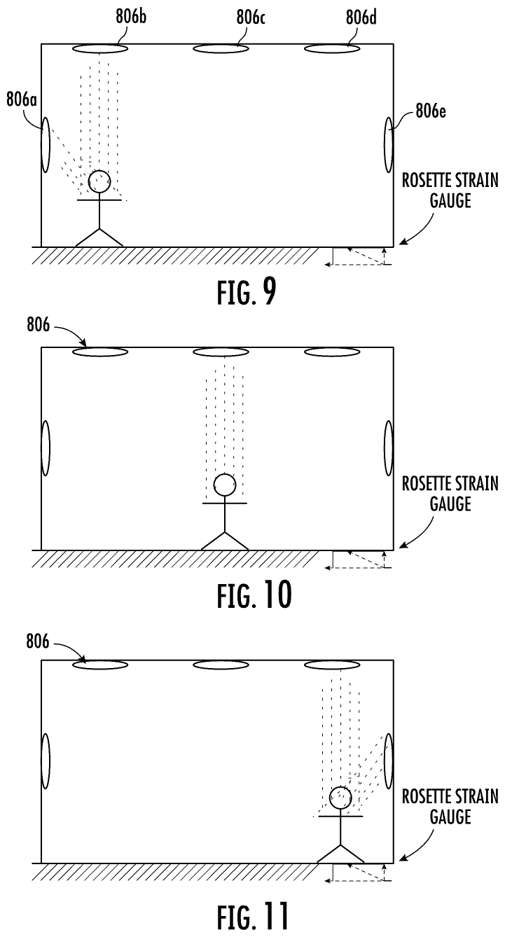

The design and arrangement of zones depicted in FIGS. 7A-7B should not be considered limiting, and it should be understood that various alterations and combinations are possible without departing from the inventive principles disclosed herein. For example, referring to FIG. 8, a shower tray assembly 704 is shown that includes a plurality of zones that are arranged in sections in a linear row extending away from the spray head. A first spray zone 706 of the plurality of zones is disposed across a first end of the shower tray 714 and beneath the spray head. A second spray zone 708 of the plurality of zones is spaced apart from the spray head by the first spray zone 706, and extends across a mid-section of the shower tray 714. A third zone 710 of the plurality of zones is disposed across a second end of the shower tray 714 that is opposite from the first end. In some embodiments, each zones occupies an equal fraction of the total area (and length) of the shower tray 714. A similar design of a shower tray assembly is shown in FIGS. 9-11. Among other benefits, such an arrangement of zones (as shown in FIGS. 8-11) can reduce the number of position sensors required to determine the user location relative to the shower tray 714 and/or spray head. For example, in the embodiment of FIG. 8, the shower tray assembly includes a single position sensor disposed at the second end of the shower tray in a cantilevered arrangement as described with reference to FIG. 2. In other embodiments, the number and/or arrangement of zones may be different.

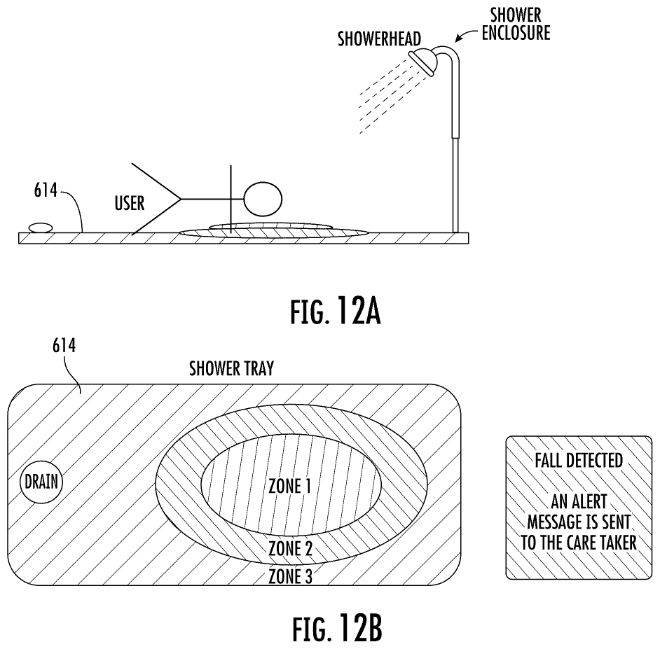

Referring to FIGS. 12A-12B, in some embodiments, operation 504 includes determining an event associated with the position signal. For example, operation 504 may include determining that a user has fallen, and/or that a user has dropped an object within the shower enclosure, based on a position signal that exceeds or otherwise satisfies a position signal threshold. In some embodiments, operation 504 includes determining a fall event based on a determination that the load is distributed (e.g., approximately equally) across multiple zones, which may correspond with a user laying across the shower tray 614. In other embodiments, operation 504 includes determining that a fall event has occurred based on momentary spike in the position signal (e.g., a spike in the position signal that persists over a period that is less than a time threshold, etc.).

Referring again to FIG. 6, at operation 506, the controller (e.g., the spray selection circuit 418, etc.) determines a spray characteristic (e.g., a flow parameter, a control parameter, etc.) based on the user location. In some embodiments, the controller determines the spray characteristic directly from the position signals from the position sensor (in which case operation 504 and operation 506 may occur at the same time). In such embodiments, operation 506 may include any of the operations described with respect to operation 504.

In some embodiments, operation 506 includes determining a flow rate of water that corresponds with the spray characteristic. For example, operation 506 may include determining a first flow rate corresponding to a user location that is indicative of the user standing within a first zone (the first spray zone 606 of FIGS. 7A-7B, the first spray zone 706 of FIG. 8, etc.), and determining a second flow rate corresponding to a user location that is indicative of the user standing within a second zone (the second spray zone 608 of FIGS. 7A-7B, the second spray zone 708 of FIG. 8, etc.). The second flow rate may be less than the first flow rate to reduce water usage when the user steps away from the spray head. For example, the second flow rate may be 50%, 30%, or another fraction of a full flow rate through the spray head. In some embodiments, operation 506 includes determining that the spray head should be deactivated based on the user position, such as in response to a determination that the user is standing within a third zone of the shower tray, etc. A similar determination may be made by the controller in response to an event, such as a fall event, and/or an event corresponding to the user dropping an item onto the shower tray. In such instances, the controller may be configured to determine that the flow rate of water provided by the spray head should be reduced, or that the spray head should be deactivated entirely.

In other embodiments, operation 506 includes determining a spray intensity, a duty cycle and/or frequency for one or more solenoid valves, control parameters for a plurality of solenoid valves, and/or another flow parameter associated with a desired spray pattern to be produced by the spray head. For example, and referring to FIGS. 9-11, operation 506 may include determining which spray head 806a-806e of a plurality of spray heads to activate based on the user location, such as by generating a command to activate only the spray heads located immediately adjacent to the user location.

Referring again to FIG. 6, at operation 508, the controller (e.g., the spray head control circuit 420, etc.) controls an actuator or multiple actuators to adjust the spray based on the spray characteristic. In some embodiments, operation 508 includes generating a control signal to control the actuator(s) based on the spray characteristic. In some embodiments, operation 508 also includes transmitting an indication of the user location to a user interface (e.g., a display, a light element(s), etc.), and presenting the user location via the user interface, as described above.

### Load-Based Occupancy Detection Using a Conductive Mat

Although embodiments herein refer to the use of one or more strain gauges to determine the user location, it should be understood that other types of position sensors may also be used instead of, or in addition to, a strain gauge and that such arrangements could also be implemented by the load-based occupancy detection systems described herein.

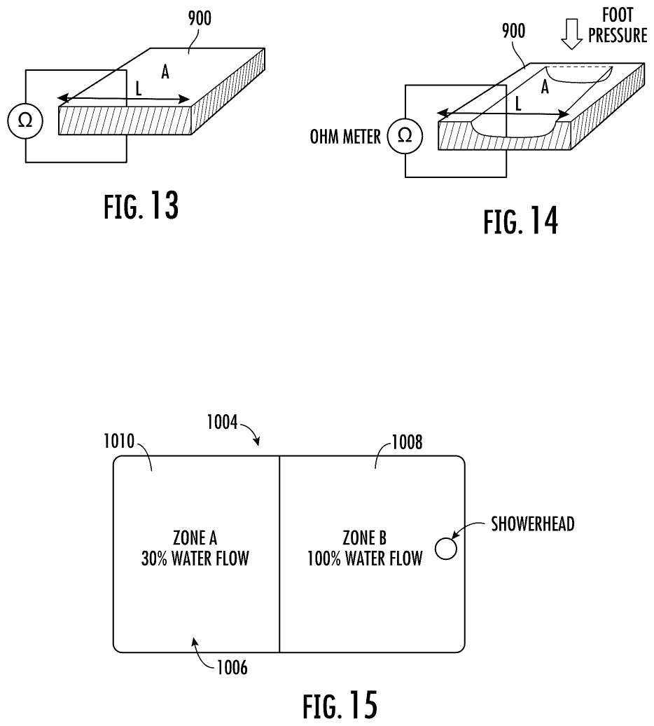

For example, referring to FIGS. 13-14, a position sensor in the form of a conductive mat 900 is shown, according to an embodiment. The conductive mat 900 may include an electrically conductive foam material having a resistivity that varies depending on displacement and/or compression of the material. In some embodiments, the resistivity of the conductive foam material varies with respect to the area of the material, as provided in equation (1) below:

$$R = ρ L / A \qquad ( 1 )$$

Where ρ is the resistivity of the material, L is the length of the material, and A is the area of the material.

Referring to FIG. 15, a shower tray assembly 1004 is shown that includes a plurality of conductive mats 1006 as position sensors for a load-based occupancy detection system, according to an embodiment. The conductive mats 1006 are separate pieces of material that extend across each zone of the shower tray assembly 1004. In the embodiment of FIG. 15, the shower tray assembly 1004 includes a pair of conductive mats, including a first conductive mat 1008 and a second conductive mat 1010 that extend across different zones along the upper surface of the shower tray assembly 1004. In other embodiments, the shower tray assembly 1004 may include a different number or arrangement of conductive mats.

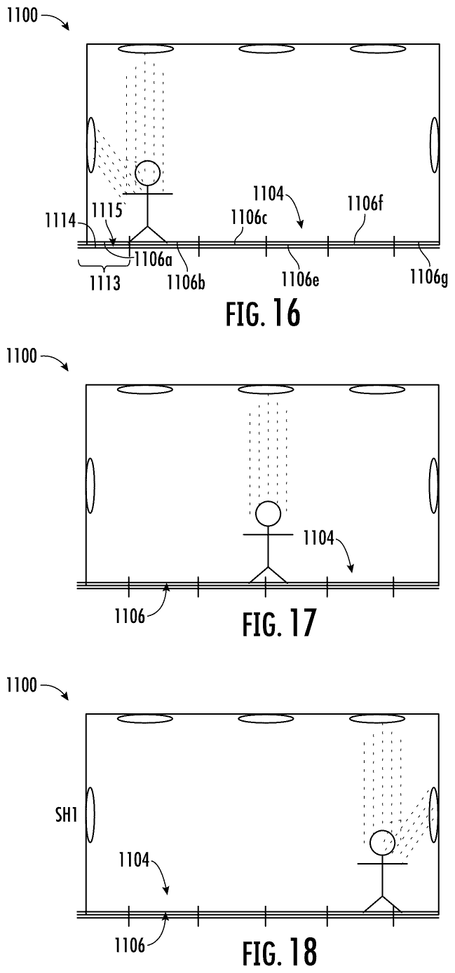

For example, referring to FIGS. 16-18, a showering system 1100 is shown that includes a plurality of conductive mats 1106a-1106f (collectively, mats 1106) arranged in linear sections (e.g., partitions, etc.) along the entire length of the shower tray assembly 1104. The conductive mats 1006 are disposed across and/or engaged with at least a portion 1113 of an upper surface 1115 of a shower tray 1114. In the embodiment of FIGS. 16-18, each conductive mat 1106a-1106f includes a rectangular strip of electrically conductive foam. However, it should be understood that the shape of at least one of the mats may be different in other embodiments.

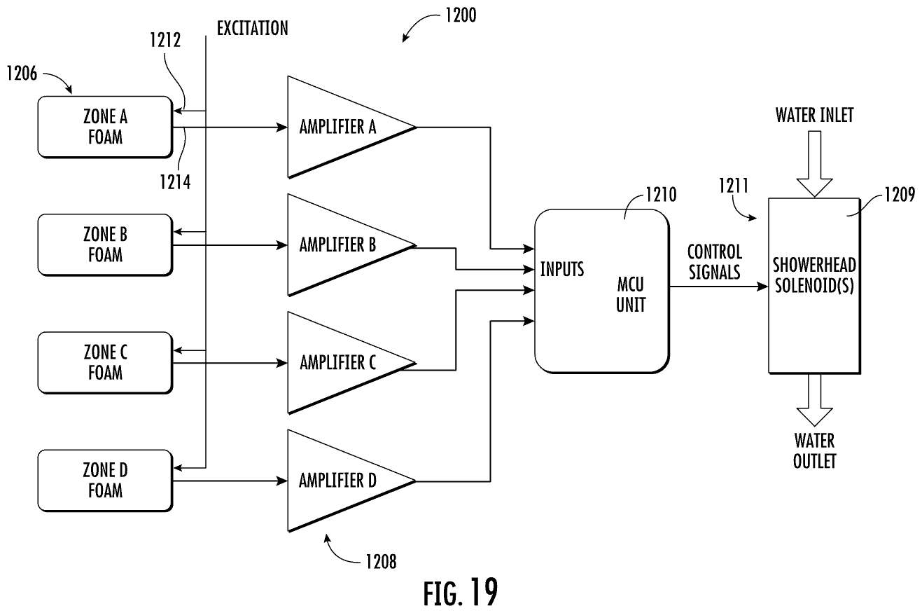

Referring to FIG. 19, a load-based occupancy detection system 1200 is shown that is configured to receive a position signal from each one of a plurality of conductive mats 1206 and to activate one, or a combination of spray heads that is/are nearest to the activated mat(s) 1206. The system 1200 includes the plurality of mats 1206 and a controller 1210. The mats 1206 are configured to be disposed across at least a portion of a surface of a shower tray (e.g., the upper surface 1115 of the shower tray 1114 of FIG. 16). Each of the mats 1206 includes an excitation terminal 1212 and an output terminal 1214. The controller 1210 is configured to be electrically coupled to the output terminal 1214 of each of the mats 1206, and is configured to control an actuator 1209 of a spray head 1211 based on electrical signals received from the output terminals 1214.

In some embodiments, the load-based occupancy detection system 1200 also includes a plurality of amplifiers 1208. In some embodiments, the system 1200 also includes a power source to provide an excitation to the mats 1206. In other embodiments, the system 1200 may include additional, fewer, and/or different components.

In the embodiment of FIG. 19, each of the mats 1206 (e.g., each section of conductive foam, etc.) is excited with a reference voltage via the plurality of excitation terminals 1212 that are coupled to the mats 1206. Each of the amplifiers 1208 are coupled to a respective one of the mats 1206 via the plurality of output terminals 1214. The amplifiers 1208 are electrically coupled between the output terminals 1214 and the controller 1210. The amplifiers 1208 are configured to scale or otherwise adjust the voltage output from each of the mats 1206 and to provide the scaled electrical signals (e.g., the position signals, etc.) to the controller 1210. The controller is communicably coupled to the amplifiers 1208 and is configured to control at least one actuator (e.g., at least one solenoid valve, etc.) based on the electrical signals from the mats 1206. For example, the controller 1210 may be configured to determine a user location along the shower tray and/or relative to the spray head based on a change in the resistivity of any one of the conductive mats 1206.

### Alternative System Configurations

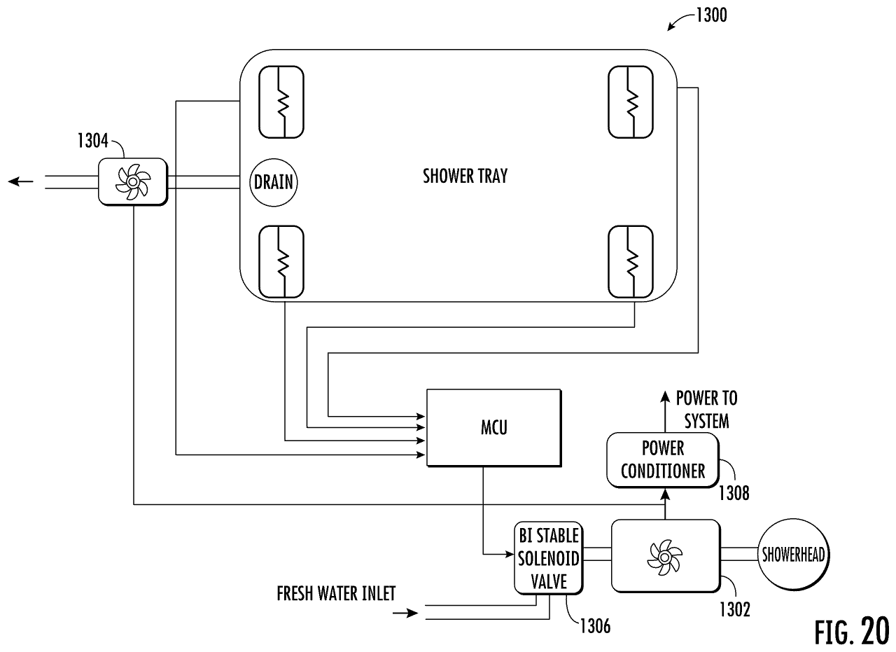

The design and arrangement of the showering system may be different in various embodiments. For example, referring to FIG. 20, a showering system 1300 is shown that is configured to operate independently from a residential or commercial power supply. The showering system 1300 is similar to the showering system 100 described with reference to FIG. 1 but also includes a plurality of hydro generators that are configured to power the load-based occupancy detection system. In the embodiment of FIG. 20, the showering system 1300 includes two hydro generators, shown as first generator 1302 and second generator 1304. The first generator 1302 is disposed upstream of a spray head of the showering system 1300, between an actuator 1306 and the spray head. In some embodiments, the actuator 1306 is a bi-directional solenoid valve which is configured to remain in a fixed position after actuation. Such an arrangement reduces power consumption during operation.

Still referring to FIG. 20, the second generator 1304 is fluidly coupled to a drain conduit and is configured to generate power from water flowing through the drain conduit. In some embodiments, both the first generator 1302 and the second generator 1304 are water turbines that generate power as a result of water flowing therethrough. In some embodiments, the system 1300 further includes a power conditioner 1308 between the generators and the controller, to control output voltage and/or current to the controller. In some embodiments, the system 1300 further includes a battery pack and/or capacitor to store excess energy generated by the generators during operation. Such an arrangement enables operation of the showering system 1300 during power outages, and can reduce costs associated with system operation.

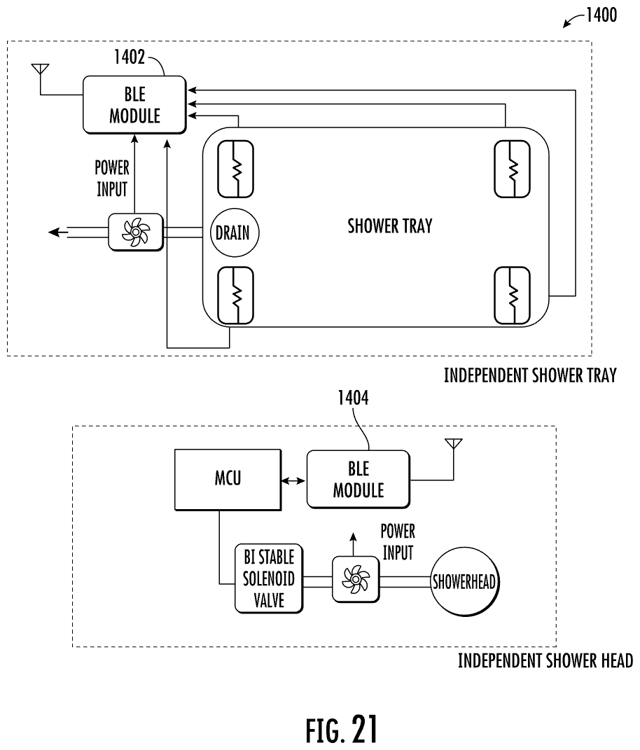

Referring to FIG. 21, a showering system 1400 is shown that includes separate control modules for the spray head actuator and the shower tray assembly. The showering system 1400 includes a pair of control modules, shown as first control module 1402 and second control module 1404, that are configured to communicably couple the spray head actuator and the shower tray assembly. In the embodiment of FIG. 21, the first control module 1402 is communicably coupled to the components of the shower tray assembly, including the position sensor(s). The first control module 1402 may also be coupled to a hydro generator disposed within the drain conduit of the shower tray assembly. The second control module 1404 is communicably coupled to a controller for the load-based occupancy detection system, which is configured to control operation of the spray head actuator. During operation, the second control module 1404 receives position signals from the first control module 1402 and may be configured to control operation of the spray head actuator based on the signals. The control modules may be wireless control modules that communicate over Bluetooth, a local area network, or another wireless connection. Such an arrangement eliminates the need for a wire harness between the shower tray assembly and the main controller. Such an arrangement can also enable retrofit of the shower tray assembly into an existing shower enclosure. In other embodiments, the position of the main controller may be different. For example, in some embodiments, the first control module 1402 is configured to determine and transmit a user location to the second control module 1404 based on the position signal(s).

### Microphone-Based Occupancy Detection System

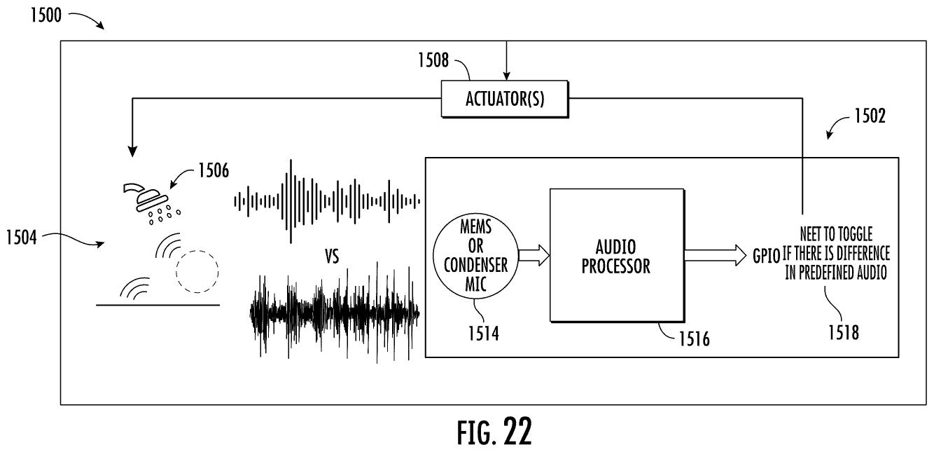

Referring to FIG. 22, a microphone-based occupancy detection system, shown as occupancy detection system 1502, for a showering system 1500 is shown, according to an embodiment. The showering system 1500 includes a shower enclosure 1504, a spray head assembly 1506 (e.g., a showerhead, a hand shower, etc.), and at least one actuator 1508. In other embodiments, the showering system 1500 may include additional, fewer, and/or different components.

The spray head assembly 1506 is configured to fluidly couple to a fluid source (e.g., a well, a plumbing system, etc.) and to discharge the fluid from the fluid source into the shower enclosure 1504.

In some embodiments, the spray head assembly 1506 includes a fluid communication member (e.g., a ball joint, a threaded coupler, etc.) that is configured to fluidly couple the spray head assembly 1506 to a fluid delivery component (e.g., a pipe, a spout, a fixture, a shower arm, etc.) such that the spray head assembly 1506 can receive the fluid from a fluid source. In some embodiments, the fluid delivery component is a water supply conduit that is configured to supply water at residential and/or commercial water supply pressures.

In some embodiments, the spray head assembly 1506 may be configured as a hand shower and/or a pull-out spray head, where the spray head assembly 1506 can be selectively repositioned respect to the fluid delivery component. Alternatively, the spray head assembly 1506 may be a showerhead that is positioned at a fixed height within the shower enclosure 1504. Although embodiments of the present disclosure are described with respect to a showering system 1500, it should be appreciated that the occupancy detection systems and methods of the present disclosure may also be used to control operation of other fluid delivery devices such as faucets for bath and kitchen applications. For example, embodiments of the occupancy detection system 1502 of the present disclosure may also be used to control spray characteristics of a spray produced by a bathroom faucet depending on a position of a user's hands with respect to the spray within a sink basin, etc.

The actuator 1508 is configured to adjust the spray produced by the spray head assembly 1506. In some embodiments, the actuator 1508 is a separate component from the spray head assembly 1506. For example, the actuator 1508 may be flow actuator and/or shower valve disposed in a fluid delivery component upstream from the spray head assembly 1506. In other embodiments, the actuator 1508 may form part of the spray head assembly 1506 and may be disposed within a housing of the spray head assembly 1506.

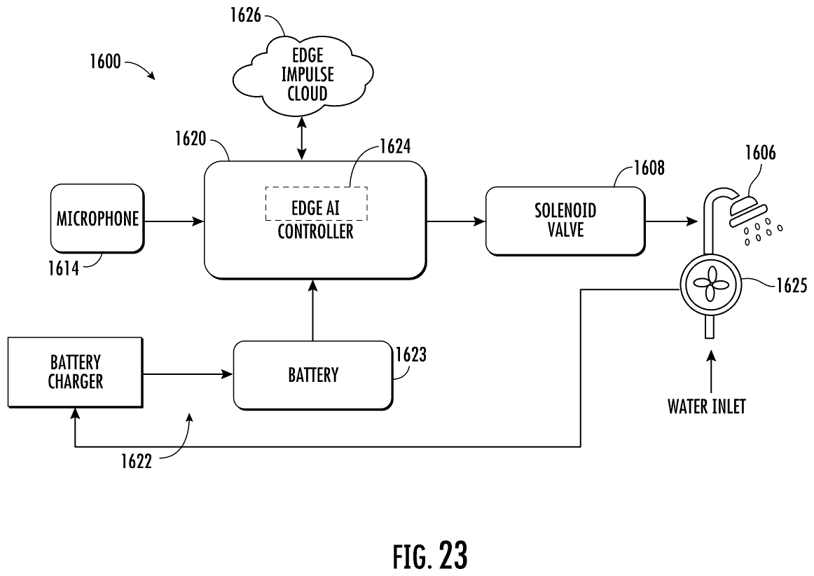

Referring to FIG. 23, in some embodiments, the actuator 1508 includes a solenoid valve 1608 that is configured to adjust one or more of a flow rate through a spray head assembly 1606, activation of a subset of nozzles of the spray head assembly 1606, a spray pattern produced by the spray head assembly 1606, and/or another characteristic of the spray produced by the spray head assembly 1606.

In some embodiments, the solenoid valve 1608 is a pulse width modulated solenoid valve that is configured to control one of a duty cycle or frequency of actuation. In some embodiments, the solenoid valve 1608 may be one of a plurality of solenoid valves that are configured to collectively control intrinsic spray characteristics of the spray.

Referring again to FIG. 22, in other embodiments, the actuator 1508 is one of a plurality of actuators (e.g., solenoids, etc.) that are configured to control the flow rate to a single spray head (e.g., a first solenoid that when opened provides a first percentage of full flow to the spray head, a second solenoid fluidly coupled to the first solenoid in parallel flow arrangement to provide a second percentage of full flow to the spray head, etc.). In yet other embodiments, the actuator 1508 is one of a plurality of actuators (e.g., solenoids, etc.) that are configured to control the flow rate to different spray head assemblies within the shower enclosure 1504. In yet other embodiments, the actuator 1508 is a thermostatic valve that is configured to control a fraction of hot water being delivered to the spray head assembly 1506.

The occupancy detection system 1502 is configured to control the actuator(s) 108 to adjust the spray based on at least one spray characteristic of the spray generated by the spray head assembly 1506. As used herein, “spray characteristic” refers to features of the spray produced between the spray head assembly 1506 and the walls of the shower enclosure 1504. For example, the spray characteristic may include an intrinsic spray characteristic of the spray such as an overall flow rate of water produced by the spray, an intensity of the spray (e.g., a flow rate of the spray per nozzle along the spray head assembly 1506, etc.), a number of droplets produced by each nozzle per second, or another characteristic of the spray head assembly 1506 that produces the spray.

Spray characteristics may also include extrinsic spray characteristics of the spray which may be affected by a user or object(s) within the shower enclosure 1504, such as a three-dimensional shape of the spray between the spray head assembly 1506 and the walls of the shower enclosure 1504. For example, an extrinsic spray characteristic may include whether an object, person, or portion thereof has been placed into the spray between the spray head assembly 1506 and the walls of the shower enclosure 1504 (e.g., a floor of the shower enclosure 1504, etc.). Extrinsic spray characteristics may also include a length of at least one stream or a plurality of streams forming the spray before impacting a surface, and/or an intensity of the spray at a location where the spray impacts the surface.

In at least one embodiment, the spray characteristic is a sound produced by the spray. For example, the spray characteristic may be a sound produced as a result of the spray impinging a floor surface of the shower enclosure 1504, a sidewall surface of the shower enclosure 1504, or a combination thereof. In other embodiments, the spray characteristic may be a sound produced by the spray impinging on a user or object within the shower enclosure 1504 between the spray head assembly 1506 and the wall(s) of the shower enclosure 1504.

In the embodiment of FIG. 22, the occupancy detection system 1502 is configured to adjust the spray based on a sound produced by the spray. The occupancy detection system 1502 includes a microphone 1514 integrated with a microcontroller or microprocessor unit (e.g., an audio processor 1516), and a communications interface 1518 configured to control inputs and outputs from the occupancy detection system 1502.

In some embodiments, the microphone 1514, the audio processor 1516, the communications interface 1518, and/or a controller of the showering and occupancy detection system may be integrated in a single control circuit (e.g., into an application specific integrated circuit (ASIC), a software on chip (SOC), etc.).

For example, referring to FIG. 23, a showering system 1600 is shown in which the audio signal processing components are integrated into a single controller 1620 of a microphone-based occupancy detection system 1602. The occupancy detection system 1602 also includes a microphone 1614, a power source 1622, and a generator 1625.

In some embodiments, the power source 1622 includes a commercial or residential power source. In some embodiments, the power source 1622 includes a battery pack 1623, such as a lithium-ion battery, to eliminate the need for wall power and to facilitate retrofit of exiting showering systems. In some embodiments, the power source 1622 also includes a battery charger to power and/or recharge the battery pack 1623. The generator 1625 is disposed upstream from the spray head assembly 1604 and is configured to generate power from water flowing therethrough. In some embodiments, the generator 1625 is a hydro generator (e.g., a turbine generator) that includes a turbine disposed within a water supply line upstream from the spray head assembly 1604. In other embodiments, the generator 1625 may include at least one of a thermo-electric generator (e.g., a generator configured to produce power from a temperature gradient across the system, etc.), photo voltaic cells, or another type of electric power generator. The generator 1625 is electrically coupled to the battery pack 1623. In other embodiments, the generator 1625 may be coupled to other components of the occupancy detection system 1602.

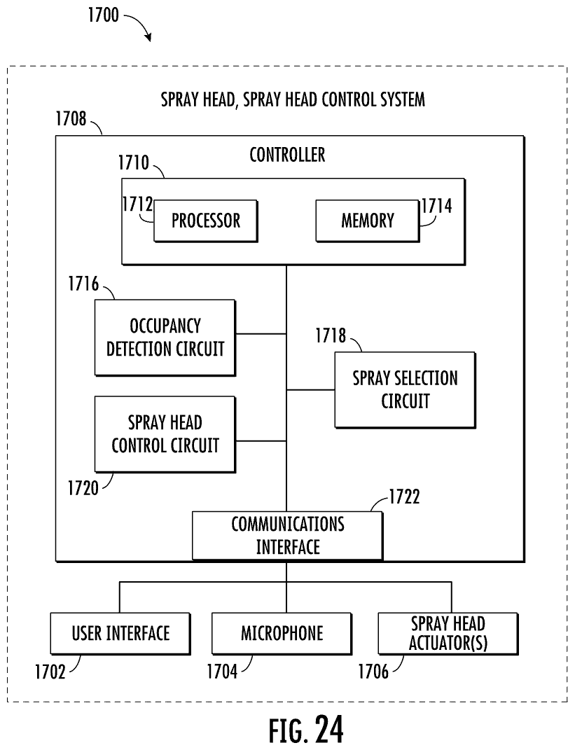

Referring to FIG. 24, an occupancy detection system 1700 is shown that may be used with the showering system 1600 of FIG. 23 (or the showering system 1500 of FIG. 22). The occupancy detection system 1700 is structured as a standalone controller for the showering system that may be located remotely from a spray head assembly (see FIG. 23). In other embodiments, the occupancy detection system 1700 and/or portions thereof may be fixedly coupled to the spray head assembly.

The occupancy detection system 1700 includes a user interface 1702, a microphone 1704, at least one actuator 1706, and a controller 1708. In other embodiments, the occupancy detection system 1700 may include additional, fewer, and/or different components.

The user interface 1702 is configured as a human-machine interface for the occupancy detection system 1700 and enables user interaction with the occupancy detection system 1700 the user interface 1702 may include an input/output interface (e.g., an I/O interface) that is configured to receive user inputs. For example, the user interface 1702 may include one or more actuators and or a touch screen display. In some embodiments, the user interface 1702 is configured to allow a user to specify flow parameters that the controller 1708 will select responsive to one or more spray characteristics, as will be further described. In some embodiments, the user interface 1702 is configured to provide an indication of a spray characteristic detected by the controller 1708. For example, the user interface 1702 may include a display and/or at least one light element (e.g., a light emitting diode, etc.) configured to provide an indication of whether an object has been placed into the spray.

In some embodiments, the user interface 1702 includes a remote computing device (e.g., a mobile phone, a tablet, a computer, etc.) that is configured to display diagnostic information and user interface elements via a mobile software application on the remote computing device. The mobile application may be configured to allow a user to specify training parameters (e.g., spray characteristics, etc.) for different operating conditions for the occupancy detection system, and may also be configured to provide a curated training experience that guides the user through a training method for the occupancy detection system. Such an arrangement enables tailoring of the functionality of the occupancy detection system based on different showering arrangements and user preferences.

The microphone 1704 is configured to generate an audio signal from audio data regarding the spray produced by the spray head assembly. In some embodiments, the microphone 1704 is a digital micro-electro-mechanical system (MEMS) microphone housing a sensor and an application-specific integrated circuit (ASIC) that is configured to process the electrical signal produced by the sensor.

In other embodiments, the microphone 1704 is an analog condenser microphone. The microphone 1704 may be disposed at various locations throughout or adjacent to the shower enclosure. In some embodiments, the microphone 1704 is integrated with the spray head assembly (e.g., the showerhead, the hand shower, etc.), such as within a housing of the spray head assembly that includes a sound port to convey sounds from within the shower enclosure to the microphone 1704. In other embodiments, the microphone 1704 may form part of a control panel that is spaced apart from the spray head assembly.

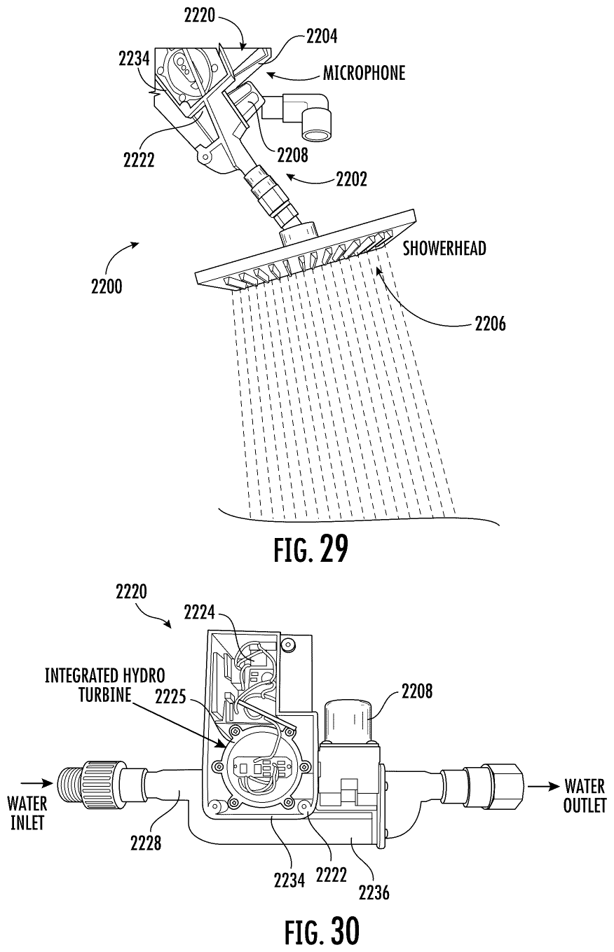

In other embodiments, the microphone 1704 may be located remote from the spray head assembly. For example, the microphone may be located in a separate unit (e.g., a control module, etc.) from the spray head assembly, as will be described in further detail with respect to the showering system 2200 of FIG. 29. In such embodiments, the unit may be located behind a wall of the shower enclosure, such as between the control valve/mixing valve and spray head assembly. The microphone may be housed within the control module, or may be connected to a sound port in at least one wall of the shower enclosure. In other embodiments, the microphone is located in a separate unit within the shower space elsewhere between the control valve/mixing valve and spray head assembly, or integrated with a digital mixing valve with the microphone attached or located elsewhere within the shower enclosure or bathroom.

The at least one actuator 1706 may be a shower valve that is configured to adjust the spray produced by the spray head assembly. The actuator(s) 306 may be the same as or similar to the actuator(s) 108 described with reference to FIG. 22 and FIG. 23.

The controller 1708 is communicably coupled to the user interface 1702, the microphone 1704, and the actuator(s) 306, and is configured to receive and interpret data from and/or control operation of the user interface 1702, the microphone 1704, and the actuator 1706. In the embodiment of FIG. 24, the controller 1708 includes a processing circuit 1710 including a processor 1712 and memory 1714; an occupancy detection circuit 1716 (e.g., an occupancy detection module, etc.); a spray selection circuit 1718 (e.g., a spray selection module, etc.); a spray head control circuit 1720 (e.g., a spray head control module, etc.); and a communications interface 1722. In other embodiments, the controller 1708 may include different arrangements of circuits.

The processor 1712 is communicably coupled to the memory 1714, the occupancy detection circuit 1716, the spray selection circuit 1718, the spray head control circuit 1720, and the communications interface 1722, and is configured to coordinate and control operations of each of the circuits and the communications interface 1722. The memory 1714 is configured to store data and or computer code for facilitating the various processes described here in the memory 1714 may include a tangible non transient volatile memory that is configured to store instructions thereon which when executed causes the processor 1712 to perform any of the operations described herein.

The occupancy detection circuit 1716, the spray selection circuit 1718, and the spray head control circuit 1720 may be embodied as software modules stored in memory 1714. For example, referring to FIG. 23, any one or a combination of the occupancy detection circuit 1716, the spray selection circuit 1718, and the spray head control circuit 1720 may be located on the same circuit board as the microphone 1704. In such arrangements, the occupancy detection circuit 1716, the spray selection circuit 1718, and/or the spray head control circuit 1720 may form part of an edge computing device 1624 that is configured to perform operations without requiring access to the Internet. Referring again to FIG. 24, in other embodiments, at least one of the occupancy detection circuit 1716, the spray selection circuit 1718, and the spray head control circuit 1720 may be embodied as a separate circuit or may form part of a cloud infrastructure component 1626 (see FIG. 23) that is communicably coupled to the controller 1708 via the Internet, as will be further described.

The occupancy detection circuit 1716 is configured to determine a spray characteristic indicative of the spray based on the audio signal from the microphone 1704. For example, the occupancy detection circuit 1716 may be configured to receive the audio signal and to determine a location of a user within a shower enclosure (e.g., in a scenario in which the audio signal is also a position signal), relative to the spray produced by the spray head assembly, and/or a shape of the spray produced by the spray head assembly based on the audio signal.

In at least one embodiment, the occupancy detection circuit 1716 is configured to implement at least one machine learning and/or deep learning algorithm to identify the spray characteristic by comparing the audio signal to reference data stored in memory 1714. In such embodiments, the occupancy detection circuit 1716 may form part of an edge computing device 1624 (see FIG. 23) (e.g., a chipset, an application specific integrated circuit, etc.) that is configured to generate and/or perform an audio comparison algorithm using machine learning and/or deep learning without requiring access to the Internet or devices located remote from the shower enclosure. Such arrangements can reduce latency and improve response times between user actions and adjustments to the spray, and can also reduce overall system complexity.

In other embodiments, the occupancy detection circuit 1716 may form or be hosted by a cloud infrastructure component 1626 that is communicably coupled to the controller 1708 over the Internet via a wired network, a wireless network, or a combination thereof. For example, the at least portions of the occupancy detection circuit 1716 may be formed as a software module that is accessible via an application programming interface (API) or other drivers stored in memory 1714 onboard the controller 1708. Such an arrangement can allow for over-the-air updates to software algorithms (e.g., machine learning algorithms, etc.) to improve classification of different spray characteristics and the use of different control algorithms to adjust the spray based on user actions.

The spray selection circuit 1718 is configured to receive the spray characteristic from the occupancy detection circuit 1716 and to determine a spray that corresponds with the spray characteristic. In some embodiments, the spray selection circuit 1718 is configured to determine a control parameter for the actuator(s) 306 to cause the actuator(s) 306 to adjust the spray based on the spray characteristic, as will be further described.

In some embodiments, the spray selection circuit 1718 is configured to control the actuator(s) 306 to adjust a flow rate of water provided by the spray head assembly into the shower enclosure. For example, the spray selection circuit 1718 may be configured to transmit a control signal to a solenoid to reduce a flow rate of water in response to a determination that the spray is flowing on the floor or other wall surfaces without any objects introduced into the spray (e.g., to 50% of a maximum flow rate relative to a supply pressure of the fluid source, 40% of the supply pressure, 30% of the supply pressure, 20% of the supply pressure, 10% of the supply pressure, or any value between and including the foregoing values, etc.). Conversely, the spray selection circuit 1718 may be configured to increase the flow rate in response to a determination that a user has stepped into the spray (e.g., to 100% of the maximum flow rate, or a different value based on user preferences, etc.). Such an arrangement can significantly reduce the amount of water used during periods in which the user is shampooing their hair, shaving, or performing other functions that do not require a full intensity spray.

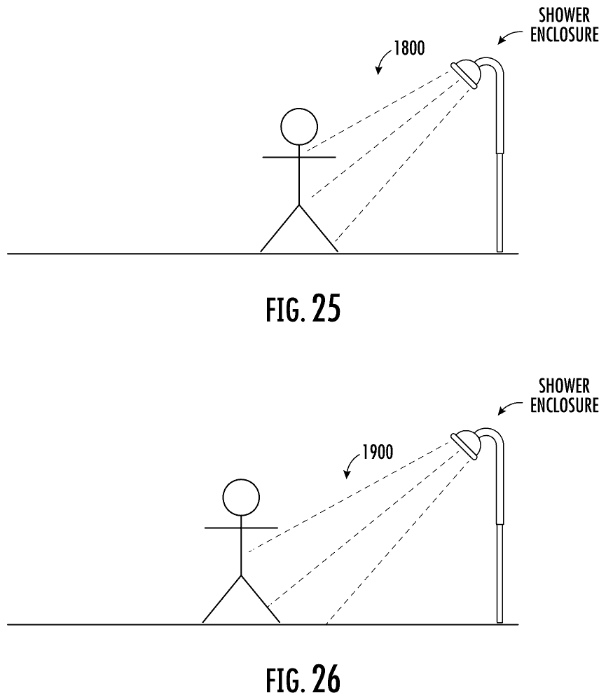

In some embodiments, the spray selection circuit 1718 is configured to generate different control signals to provide intermediate spray intensities depending on how much of the spray is being occupied by a user. For example, referring to FIG. 25 and FIG. 26, the spray selection circuit 1718 (see also FIG. 24) may be configured to adjust the flow rate, intensity, or other flow parameters depending on how much of the spray is being blocked by a user, such as whether the entire spray is blocked (spray 1800 of FIG. 25) or only a portion of the spray is blocked (spray 1900 of FIG. 26).

In some embodiments, the spray selection circuit 1718 is configured to control the actuators 1706 to adjust a flow rate of water and/or another aspect of the spray based on user inputs and/or template spray patterns that are defined by a user and stored in memory 1714.

Referring again to FIG. 24, the spray head control circuit 1720 is configured to receive the control parameter control the actuator(s) 306 from the spray selection circuit 1718 and to generate and transmit a control signal based on the control parameter. The control signal may cause the actuator(s) 308 to close, to change a duty cycle and/or frequency of a solenoid valve, or to activate/deactivate subsets of nozzles along one or more spray head assemblies within the shower enclosure.

The communications interface 1722 is configured to control data exchange between various components of the showering system and the controller 1708. The communications interface 1722 may include a wired and or wireless interface (e.g., Bluetooth, a local area network (LAN), near field communications, etc.) for conducting communications.

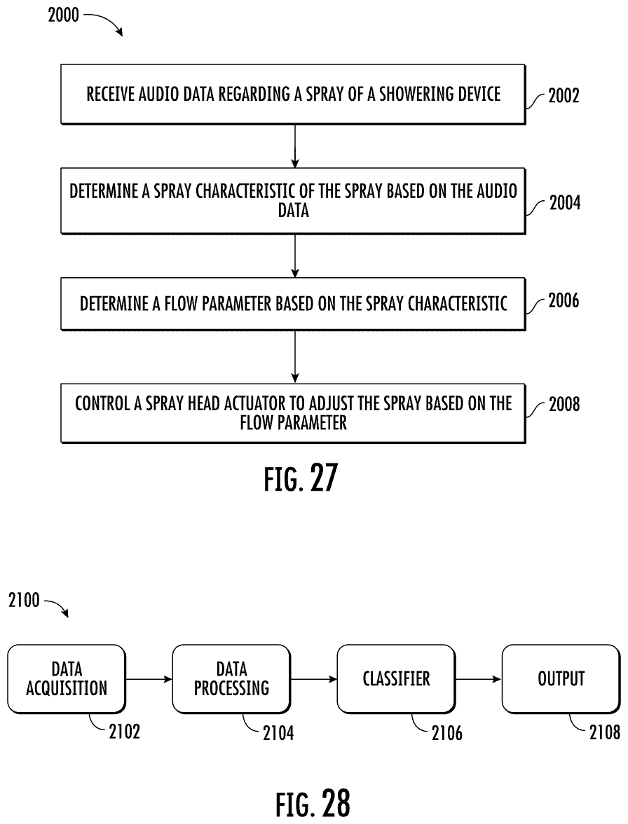

Referring to FIG. 27, a method 2000 of controlling a spray head assembly using a microphone-based occupancy detection system is shown, according to an embodiment. The method 2000 may be implemented by the occupancy detection system 1700 of FIG. 26 and, as such, will be described with reference to the occupancy detection system 1700. In other embodiments, the method 2000 may include additional, fewer, and/or different operations.

At operation 2002, the controller (e.g., the controller 1708, the occupancy detection circuit 1716, etc.) receives audio data regarding a spray produced by a spray head assembly. In some embodiments, operation 2002 includes receiving, by a microphone (e.g., microphone 1704) sound produced by a spray that is generated by the spray head assembly. Operation 2002 may include processing the audio data, such as via an analog to digital processor to facilitate further processing operations.

At operation 2004, the controller (e.g., the occupancy detection circuit 1716, etc.) determines a spray characteristic indicative of the spray based on the audio signal. In some embodiments, operation 2004 includes determining the spray characteristic based on a sound produced by the spray within the shower enclosure. For example, operation 2004 may include determining a first spray characteristic in response to an audio signal indicating that the spray is not being blocked by a user or object, and determining a second spray characteristic in response to an audio signal indicating that a user has entered the spray.

In some embodiments, the controller determines the spray characteristic based on threshold sound levels stored in memory. For example, the controller may be configured to use a lookup table that includes spray characteristics associated with different sound levels (e.g., average decibel levels, etc.) to determine the spray characteristic based on the audio signal.

In some embodiments, operation 2004 includes using a machine learning and/or deep learning algorithm to determine the spray characteristic from the audio signal. Referring to FIG. 28, a method 2100 of determining a spray characteristic from an audio signal is shown, according to an embodiment. In other embodiments, the method 2100 may include additional, fewer, and/or different operations.

At operation 2102, the controller acquires the audio signal. Operation 2102 may include receiving at least one subset of audio samples of the audio signal, each of which may include one or more audio samples of audio data over a sampling period.

At operation 2104, the controller processes the at least one subset of audio samples to determine at least one audio characteristic of the audio sample(s). In some embodiments, operation 2104 includes averaging the audio samples in the at least one subset to determine an average audio signal. In some embodiments, operation 2104 includes using an audio Mel-filterbank energy (MFE) processing block to extract time and frequency features from the audio signal. In such embodiments, operation 2104 may include using a non-linear scale in the frequency domain, such as the Mel-scale which can improve recognition of spray characteristics (e.g., non-voice recognition, etc.) from the audio signal, such as by extracting more features in lower frequency scales as compared to higher frequencies. In some embodiments, operation 2104 includes determining a Fourier transform (e.g., a fast Fourier transform, etc.) of the audio sample(s) and/or the average audio signal.

At operation 2106, the controller classifies the audio sample(s) and/or the average audio signal using existing audio signals stored in memory. For example, operation 2106 may include comparing the Fourier transform with existing audio signal datasets using a classifier, such as a neural network for the deep learning model (e.g., a convolutional neural network, a feedforward neural network, etc.). In other embodiments, operation 2106 may include using logistic regression, or another type of classifier algorithm to determine the spray characteristic that is associated with the audio signal.

At operation 2108, the controller outputs the spray characteristic that corresponds with the audio signal received.

It should be understood that a similar method may be used to train the machine learning and/or deep learning model, which can enable use of the model with different spray head assemblies and shower enclosure designs (e.g., different enclosure materials, different enclosure geometries, etc.). For example, the method 2100 may include storing a plurality of datasets of the audio signal, including a first dataset of the audio signal corresponding to a first spray characteristic of the spray (e.g., corresponding to an unimpeded spray that impinges on the wall(s) of the shower enclosure, etc.), and a second dataset of the audio signal corresponding to a second spray characteristic (e.g., corresponding to a user fully immersed in the spray, etc.). The method 2100 may further include training a classifier to associate the first dataset with the first spray characteristic and the second dataset with the second spray characteristic.

In some embodiments, the training method may include providing at least 20 samples of the audio signal in each intended use condition to the machine learning and/or deep learning model. For example, in an embodiment in which the classifier is trained to distinguish between spray characteristics including the spray impinging on (i) at least a portion of the user, an object, or (ii) the floor, the method 2100 may include collecting data under different operating conditions corresponding to each of these spray characteristics. In such an embodiment, the method 2100 may include collecting data corresponding to the spray impinging on a lower surface (e.g., a floor) of the shower enclosure at different flow rates of operation. The method 2100 may also include collecting data corresponding to the spray impinging on one or more objects (e.g., the user, etc.) at different flow rates so as to enable the classifier to distinguish between each of these operating conditions and spray characteristics. Once trained, if the classifier is configured to use the training data to predict whether the spray characteristic corresponds to a spray impinging on the floor only or a user (regardless of the flow rate). The controller may control the actuator to reduce a flow rate through the spray head assembly based on the prediction.

Referring again to FIG. 27, at operation 2006, the controller (e.g., the spray selection circuit 1718, etc.) is configured to determine a flow parameter (e.g., a control parameter, etc.) based on the spray characteristic. In some embodiments, operation 2006 includes determining a flow rate of water that corresponds with the spray characteristic. For example, operation 2006 may include determining a first flow rate corresponding to a spray characteristic indicative of an unimpeded spray, and/or determining a second flow rate corresponding to a spray characteristic indicative of an at least partially impeded spray. The second flow rate may be greater than the first flow rate so as to ensure that as much water as possible is provided to the user when they step into the spray, while reducing the amount of water consumed when the user steps out of the spray to shave or apply shampoo to their hair.

In other embodiments, operation 2006 includes determining a spray intensity, a duty cycle and/or frequency for one or more solenoid valves, control parameters for a plurality of solenoid valves, or another flow parameter associated with a desired spray pattern to be produced by the spray head assembly.

At operation 2008, the controller (e.g., the spray head control circuit 1720, etc.) controls at least one actuator to adjust the spray based on the flow parameter. In some embodiments, operation 2008 includes generating a control signal to control the actuator(s) based on the flow parameter.

The design and arrangement of the microphone-based occupancy detection system may be different in various embodiments. For example, referring to FIG. 29, a showering system 2200 is shown that includes a microphone-based occupancy detection system 2202 that is located remote from a spray head assembly 2206. The occupancy detection system 2202 includes a control module 2220 that is configured to control operation of at least one actuator of the showering system 2200.

In the embodiment of FIG. 29, the control module 2220 is connected to the spray head assembly 2206, to an inlet of the spray head assembly 2206 (e.g., a showerhead), so that the control module 2220 is disposed between the spray head assembly 2206 and a water supply line extending from a wall of the shower enclosure. In such embodiments, the control module 2220 may be disposed between the spray head assembly 2206 and a mixing valve for the showering system 2200. In other embodiments, at least portions of the control module 2220 may be disposed at another location, such as behind a wall of the shower enclosure. Among other benefits, the use of a control module 2220 enables retrofit of existing showering systems with the occupancy detection system 2202.

Referring to FIGS. 30-33, the control module 2220 includes a module housing 2222, an actuator 2208, a microphone 2204, and control circuitry 2224 for the occupancy detection system 2202. The control module 2220 also includes a generator 2225 that is configured to supply power to the actuator 1508 and/or the control circuitry 2224. In other embodiments, the control module 2220 may include additional, fewer, and/or different components.

Referring to FIG. 30, the module housing 2222 includes a water passage 2228 (e.g., a flow conduit, a channel, etc.) having a water inlet connection 2230 and a water outlet connection 2232. The module housing 2222 also includes enclosure 2234 defining a cavity that is sized to receive the control circuitry 2224 therein. In some embodiments, the generator 2225 is also disposed within the cavity and is fluidly coupled to the water passage 2228. The module housing 2222 also includes a cover that is configured to sealingly engage the enclosure 2234 and to provide waterproofing of the module housing 2222.

The actuator 2208 is coupled to the water passage 2228 downstream from the generator 2225. In other embodiments, the generator 2225 is disposed downstream from the actuator 2208, which can enable utilization of water flow through a bypass valve and/or a bypass passage that is associated with the control module 2220, as will be further described. In the embodiment of FIG. 30, the actuator 2208 is a solenoid valve that is configured to control a flow rate of water through the water passage 2228. The solenoid valve may be electrically coupled to the control circuitry 2224. The control circuitry 2224 is configured to generate a control signal to actuate the solenoid valve between an open position in which the solenoid valves provides a full flow rate of water through the water passage 2228 and a closed position in which no water flows through the water passage 2228.

In the embodiment of FIG. 30, the control module 2220 also includes a bypass valve 2236 coupled to the water passage 2228. The bypass valve 2236 is configured to provide a continuous supply of water across the actuator 2208. In some embodiments, the bypass valve 2236 is configured to meter flow through the control module 2220 to a first flow rate, and the actuator 2208, when switched to an open position, is configured to meter flow through the control module 2220 to a second flow rate that is greater than the first flow rate.

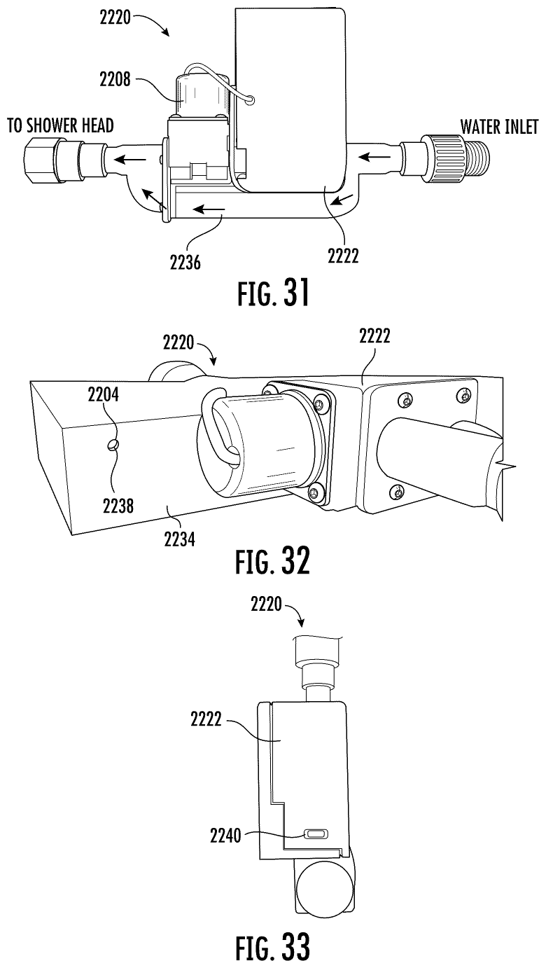

Referring to FIG. 31, in some embodiments, the bypass valve 2236 includes a flow restriction (e.g., an orifice, etc.) that is configured to bypass water across the actuator 2208 at a first flow rate that is approximately 30% of a full flow rate through the control module 2220, which can provide flow reduction while still allowing enough flow to allow a user to accurately assess a temperature of the water produced by the spray head assembly and/or to step into the shower enclosure without getting wet. In other embodiments, the bypass valve 2236 may be configured to meter water to a different percentage of the full flow rate. Including a bypass valve 2236 as described can enable operation of the spray head assembly at multiple different flow rates depending on sounds generated within the shower enclosure and without requiring multiple separate solenoid valves. Such an arrangement can also reduce the risk of thermal shock associated with a change in the water temperature from the water supply line.

Referring to FIG. 32, the microphone 2204 is disposed within the cavity proximate to the control circuitry. The microphone 2204 is coupled to a sidewall of the enclosure 2234 and adjacent to a sound port 2238 that is defined by the sidewall. In some embodiments, the sound port 2238 is a through-hole opening that extends through the sidewall. In some embodiments, the microphone 2204 is sealingly engaged with the sidewall at the sound port 2238 to prevent water from leaking into the cavity through the sound port 2238.

In some embodiments, the sound port 2238 and microphone 2204 are arranged to face toward the spray head assembly when the control module 2220 is fluidly coupled to the spray head assembly (see FIG. 29). For example, the sound port 2238 may be arranged along a sidewall of the enclosure 2234 to face toward the water outlet connection 2232, which can improve transmission of sound from sprays produced by the spray head assembly to the microphone 2204. In other embodiments, the microphone 2204 and the sound port 2238 may be disposed at another location along the enclosure 2234 or remotely therefrom.

Referring to FIG. 33, the control module 2220 also includes a connector port 2240 (e.g., a communications interface, etc.) that is configured to facilitate integration of a user interface (e.g., a tablet, a mobile phone, a computer, etc.) for the control module 2220. In some embodiments, the control module 2220 is configured to provide diagnostic information to the user interface via the connector port 2240. In some embodiments, the control module 2220 is configured to receive control commands (e.g., user inputs, etc.) such as operating preferences for one or more users based on one or more spray characteristics that are detected by the occupancy detection system 2202.

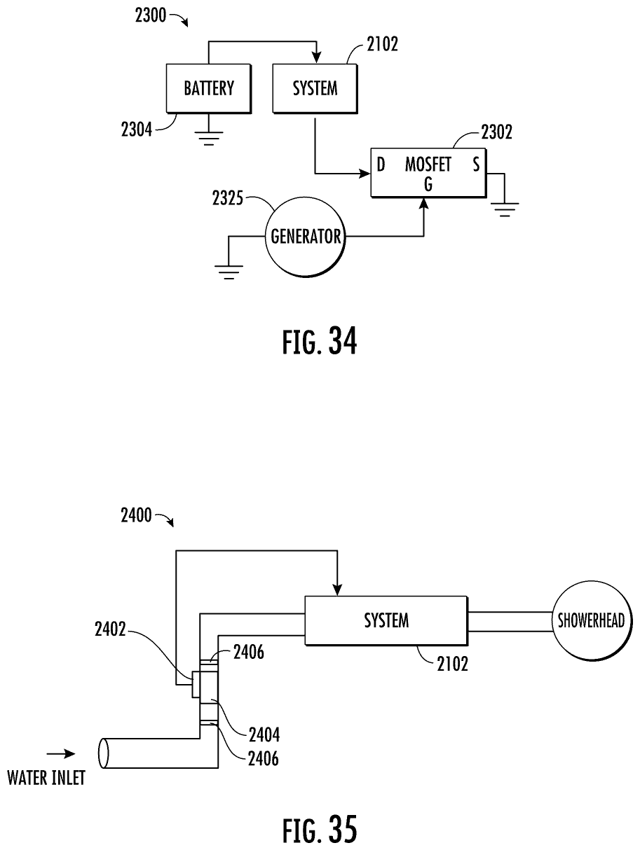

In some embodiments, the control module 2220 is a self-powered unit that is powered by the generator 2225. For example, referring to FIG. 34, the control module may include a start-up system 2300 that is configured to control activation of the occupancy detection system 2202 based on whether a user has turned on a valve upstream of the spray head assembly (e.g., based on whether the user has activated the spray head assembly). In the embodiment of FIG. 34, the start-up system 2300 includes the generator 2325, an electronic switch 2302, and a battery 2304.

The generator 2325 is coupled to the electronic switch 2302 and is configured to generate sufficient power to activate the electronic switch 2302 at low flow rates, such as when water is only flowing through the bypass valve. In the embodiment of FIG. 34, the electronic switch 2302 is a MOSFET that activates the occupancy detection system when the spray head assembly is activated. Such an arrangement eliminates the need for standby current to be supplied to the occupancy detection system, which can increase the overall battery life of the system. Any excess power produced by the generator 2325 may be stored in the battery 2304.

The structure of the start-up system 2300 may be different in various embodiments. For example, referring to FIG. 35, a start-up system 2400 includes a mechanically actuated switching mechanism to control activation of the occupancy detection system 2202. The start-up system 2400 includes a reed switch 2402, a magnetic element 2404, and a support structure 2406. The start-up system 2400 may also include a battery to store power generated during system operation.

The reed switch 2402 is coupled to a water supply line upstream from the control module and is configured to control activation of the occupancy detection system 2202. The magnetic element 2404 is disposed in a vertical leg of the water supply line between a shower control valve and the control module. The magnetic element 2404 is configured to move within the water supply line and activate the reed switch 2402 in response to activation of the shower control valve (e.g., in response to a flow of water through the water supply line, etc.). In some embodiments, the magnetic element 2404 is a magnetic ball that is disposed within the water supply line. The support structure 2406 is configured to limit movement of the magnetic element 2404 within the water supply line, such as between an on-position in which the magnetic element 2404 is aligned with the reed switch 2402 and an off-position in which the magnetic element 2404 is displaced from the on-position (e.g., below the reed switch 2402 under the force of gravity, etc.). Such an arrangement can increase battery life by eliminating the need to supply a continuous current to the control module.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the application as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the apparatus and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A spray head control system comprising:
a spray head actuator configured to control a spray generated by a spray head;
a position sensor configured to generate a position signal indicative of a user location within a shower enclosure based on a load applied to the position sensor; and
a controller communicably coupled to the position sensor and the spray head actuator, the controller configured to:
receive the position signal from the position sensor;
determine a spray characteristic of a spray produced by the spray head based on the position signal; and
control the spray head actuator based on the spray characteristic.

2. The spray head control system of claim 1, wherein the spray head actuator includes a solenoid valve, and wherein the controller is configured to control the solenoid valve to adjust a flow rate of water through the spray head based on the user location.

3. The spray head control system of claim 1, wherein the position sensor includes at least one of a load cell, a conductive foam, or a microphone.

4. The spray head control system of claim 1, wherein the controller is configured to determine the spray characteristic based on a comparison between the position signal and a plurality of position values corresponding with different user locations over a shower tray, wherein the controller is configured to control the spray head actuator based on the spray characteristic that corresponds with one of the plurality of position values.

5. The spray head control system of claim 1, further comprising a shower tray assembly including a tray support and a shower tray at least partially cantilevered away from the tray support, wherein the position sensor is coupled to the shower tray assembly proximate to the tray support.

6. The spray head control system of claim 1, wherein the spray characteristic varies depending on a distance between a user and the spray head.

7. The spray head control system of claim 6, wherein the position signal is indicative of a distance between a user and the spray head, and wherein the controller is further configured to adjust a flow rate of water through the spray head based on the distance.

8. The spray head control system of claim 6, wherein the position sensor is one of a plurality of position sensors, wherein the position sensors include conductive mats that are configured to extend across different regions of a shower tray of the shower enclosure.

9. The spray head control system of claim 1, wherein the spray characteristic includes at least one of an overall flow rate of water produced by the spray head, an intensity of the spray, a spray pattern, a number of droplets produced by a nozzle of the spray head per second, or a number of sprays.

10. The spray head control system of claim 1, further comprising a user interface communicably coupled to the controller, wherein the controller is further configured to transmit an indication of the user location to the user interface.

11. A spray head control system comprising:
a plurality of conductive foam mats configured to be disposed across at least a portion of a surface of a shower tray, each of the plurality of conductive foam mats comprising an excitation terminal and an output terminal; and
a controller configured to be electrically coupled the output terminal of each of the conductive foam mats, the controller configured to control an actuator of a spray head based on electrical signals received from the output terminals.

12. The spray head control system of claim 11, further comprising a plurality of amplifiers electrically coupled between the output terminals and the controller, the amplifiers configured to adjust a voltage output from the conductive foam mats.

13. The spray head control system of claim 11, wherein the electrical signals are indicative of a change in resistivity of the conductive foam mats, and wherein the controller is further configured to determine a user location based on a change in resistivity.

14. The spray head control system of claim 13, wherein the controller is configured to control the actuator to adjust a flow rate of water through the spray head based on the user location.

15. The spray head control system of claim 11, wherein each of the conductive foam mats are configured to be excited with a reference voltage via the excitation terminals.

16. A method comprising:
receive a position signal from a position sensor that is indicative of a user location within a shower enclosure;
determine a spray characteristic of a spray based on the position signal; and
control an actuator of a spray head based on the spray characteristic.

17. The method of claim 16, further comprising determining the spray characteristic based on a comparison between the position signal and a plurality of position values corresponding with different user locations over a shower tray, and controlling the actuator based on the spray characteristic that corresponds with one of the plurality of position values.

18. The method of claim 16, wherein receiving the position signal comprises at least one of (i) receiving the position signal from a conductive foam mat, or (ii) receiving the position signal from a microphone.

19. The method of claim 16, wherein determining the spray characteristic comprises determining at least one of an overall flow rate of water produced by the spray head, an intensity of the spray, a spray pattern, a number of droplets produced by a nozzle of the spray head per second, or a number of sprays.

20. The method of claim 16, further comprising transmitting an indication of the user location within the shower enclosure to a user interface to cause the user interface to display the user location.
